(19) United States
(12) Patent Application Publication
(10) Pub. No.: US 2009/0022367 A1
(43) Pub. Date: Jan. 22, 2009

(54) THREE-DIMENSIONAL SHAPE DETECTING DEVICE AND THREE-DIMENSIONAL SHAPE DETECTING METHOD

(75) Inventor: Hiroyuki SASAKI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/242,554

(22) Filed: Sep. 30, 2008

Related U.S. Application Data
(63) Continuation-in-part of application No. PCT/JP2007/056416, filed on Mar. 27, 2007.

(30) Foreign Application Priority Data
Mar. 31, 2006 (JP) 2006-099555

(51) Int. Cl. G06K 9/00; H04N 5/228

(52) U.S. Cl. 382/103; 348/222.1; 348/E05.031

(57) ABSTRACT

A three-dimensional shape detection device which can detect a three-dimensional shape of an object to be picked up even in the case that an image pick-up part with a narrow dynamic range is used is disclosed. An image of an object to be picked up is picked up under a plurality of different exposure conditions in a state that each of a plurality of kinds of patterned lights alternatively disposing bright and dark portions is time-sequentially projected to the object to be picked up and a plurality of brightness images are generated on for respective exposure conditions. Further, based on such a plurality of the brightness images, a coded image is formed on each exposure condition and a code edge position for a space code is obtained for every exposure condition. Based on a plurality of code edge positions for every exposure condition obtained in this manner, one code edge position for calculating a three-dimensional shape of the object to be picked up is determined such that the three-dimensional shape of the object to be picked up is calculated.

### CROSS-REFERENCE TO RELATED APPLICATIONS

The present application is a Continuation-in-Part of International Application PCT/JP2007/056416 filed on Mar. 27, 2007, which claims the benefits of Japanese Patent Application No. 2006-099555 filed on Mar. 31, 2006.

### BACKGROUND OF THE INVENTION

1. Field of the Invention

The present invention relates to a three-dimensional shape detection device and a three-dimensional shape detection method, and more particularly to a three-dimensional shape detection device and a three-dimensional shape detection method which detect a three-dimensional shape of an object to be picked up within an imaging region by projecting patterned lights to the object to be picked up, by picking up an image of the object to be picked up to which the patterned lights are projected, and by extracting trajectories of the patterned lights from the image picked up.

2. Description of the Related Art

Conventionally, there has been known a three-dimensional shape detection device which projects patterned lights such as slit lights or spot lights to an object to be picked up which constitutes an object to be detected from a projection part, picks up the object to be picked up to which the patterned lights are projected using a CCD camera or the like, and detects a three-dimensional shape of the object to be picked up based on trajectories of the patterned lights detected from the picked-up image.

With respect to such a three-dimensional shape detection device, as a three-dimensional shape detection method, there has been known an active-type measuring method and a passive-type measuring method. As a representative of such an active-type measuring method, there has been known a space coding method which projects a plurality of patterned lights.

The active-type measuring method which projects the patterned lights exhibits dependency on the surface reflection characteristic of the object to be picked up and hence, the object to be picked up is limited. That is, on a surface of the object to be picked up, there may exist a surface where reflection components of patterned lights projected on a surface of the object cannot expect sufficient intensity necessary for observation or a surface where the intensity of the reflection components is excessively strong. As such a surface, a low reflection surface, an extremely fine structural surface, a mirror reflection surface, a surface of color having complementary relationship with color of projected light or the like is named. In such a case, there exists possibility that the detection of a three-dimensional shape becomes difficult.

Accordingly, the conventional three-dimensional shape detection device copes with such a drawback by adjusting a quantity of light emitted from a light source for projecting patterned lights or by adjusting the exposure at the time of picking up an image by an image pick-up part (for example, see JP-A-8-35828).

### SUMMARY OF THE INVENTION

However, depending on the object to be picked up, there exists a case that regions having various reflection characteristics such as a low reflection region and a high reflection region are distributed on a surface of an object to be picked up. Even when the above-mentioned countermeasure is taken in such a case, the detection of the three-dimensional shape of the object to be picked up cannot be sufficiently performed.

That is, when the reflection distribution on the surface of the object to be picked up covers a wide range extending from the low reflection to the high reflection, even when a quantity of light of a light source for transmitting patterned lights is adjusted or even when the exposure at the time of picking up an image by an image pick-up part is adjusted, such adjustments cannot cover the above-mentioned reflection distribution of wide range.

For example, when a stop of the image pick-up part is opened or an exposure time is prolonged for detecting the three-dimensional shape in the low reflection region of the surface of the object to be picked up, to the contrary, the detection of the three-dimensional shape in the high reflection region of the surface of the object to be picked up becomes difficult. On the other hand, with respect to an opposite case, when the stop of the image pick-up part is closed or the exposure time is shortened for detecting the three-dimensional shape in the high reflection region of the surface of the object to be picked up, to the contrary, the detection of the three-dimensional shape in the low reflection region of the surface of the object to be picked up becomes difficult. That is, although the detection of three-dimensional shape is possible in one region, the detection of three-dimensional shape is impossible in another region.

Accordingly, the use of an image pick-up part having a wide dynamic range is considered. That is, the image pick-up part having a dynamic range which covers the wide-range reflection distribution of the object to be picked up may be adopted.

However, the image pick-up part having such a wide dynamic range is expensive and hence, a manufacturing cost of the three-dimensional shape detection device is pushed up.

Accordingly, it is an object of the present invention to provide a three-dimensional shape detection device which can detect a three-dimensional shape of an object to be picked up even when an image pick-up part having a narrow dynamic range is used.

To overcome such an object, according to a first aspect of the present invention, there is provided a three-dimensional shape detection device which is configured to detect a three-dimensional shape of an object to be picked up within a image pick-up region based on information on an image which is picked up by projecting patterned lights which are formed by alternately arranging brightness and darkness to the object to be picked up, wherein the three-dimensional shape detection device includes: a projection part which is configured to project the respective patterned lights to the object to be picked up; an image pick-up part which is configured to pick up the object to be picked up in a state that the patterned lights are projected from the projection part under a plurality of different exposure conditions; a patterned light trajectory extracting unit which is configured to extract trajectory of the patterned light from a pick-up image picked up by the image pick-up part for every exposure condition; a pattern trajectory integration unit which is configured to determine one pattern trajectory position for calculating a three-dimensional shape of the object to be picked up based on a pattern trajectory position for every exposure condition extracted by the patterned light trajectory extracting unit; and a three-dimensional shape calculation unit which is configured to calculate the three-dimensional shape of the object to be picked up based on the pattern trajectory position determined by the pattern trajectory integration unit.

According to another aspect of the present invention, there is provided a three-dimensional shape detection method of detecting a three-dimensional shape of an object to be picked up within an image pick-up region based on information on an image which is picked up by projecting patterned lights which are formed by alternately arranging brightness and darkness to the object to be picked up, the three-dimensional shape detection method including the steps of: projecting the respective patterned lights on the object to be picked up by the projection part; picking up the object to be picked up by an image pick-up part in a state that the respective patterned lights are projected from the projection part by a projection part under a plurality of different exposure conditions; extracting trajectories of the patterned lights based on a pick-up image picked up by the image pick-up part for every exposure; determining one pattern trajectory position for calculating a three-dimensional shape of the object to be picked up based on a pattern trajectory position for every extracted exposure condition; and calculating the three-dimensional shape of the object to be picked up based on the determined pattern trajectory position.

### BRIEF DESCRIPTION OF THE DRAWINGS

FIG. 1 is a perspective view showing the exterior of a three-dimensional shape detection device which is constructed according to a first illustrative embodiment of the present invention;

FIGS. 2A and 2B are a side view and a rear view both showing the three-dimensional shape detection device depicted in FIG. 1;

FIG. 3 is a rear view showing an attachment mechanism of a measurement head holder depicted in FIG. 1 with a part in cross section;

FIG. 4 is a rear cross-sectional view showing a turntable part depicted in FIG. 1;

FIG. 5 is a sectional plan view showing the interior structure of a measurement head depicted in FIG. 1;

FIG. 6 is a plan view showing a projection unit depicted in FIG. 1, in an enlarged manner;

FIG. 7 is a block diagram conceptually showing an electrical configuration of the three-dimensional shape detection device depicted in FIG. 1;

FIG. 8 is a front view showing a projection mechanism depicted in FIG. 5;

FIG. 9 is a side view showing the projection mechanism depicted in FIG. 8 with a part in cross section;

FIG. 10 is a front view partly showing a mask depicted in FIG. 8 in an enlarged manner;

FIG. 11A is a front view partly showing the mask depicted in FIG. 8, and FIG. 11B is a side view showing a position sensor and first to third ID sensors, all of which are depicted in FIG. 7, together with the mask;

FIG. 12 is a timing chart for explanation of a signal PD of the position sensor depicted in FIG. 11 and signals of the first to third ID sensors depicted in FIG. 11;

FIG. 13 is a flow chart conceptually showing a main operation implemented in a camera control program depicted in FIG. 7;

FIG. 14 is a flow chart conceptually showing stereoscopic image processing depicted in FIG. 13;

FIG. 15 is a flow chart conceptually showing three-dimensional shape-and-color detection processing depicted in FIG. 14 as a three-dimensional shape-and-color detection processing routine;

FIG. 16 is a flow chart conceptually showing a step depicted in FIG. 15 as an image-pick-up processing program;

FIG. 17 is a flow chart conceptually showing a step depicted in FIG. 16, in the name of a mask-motor control program;

FIG. 18 is a flow chart conceptually showing a projecting processing depicted in FIG. 16 as a projecting processing subroutine;

FIG. 19 is a view for explaining exposure conditions of an image pick-up part shown in FIG. 8;

FIG. 20 is a conceptual view of parameter table for respective exposures in a parameter table storing part for respective exposures in FIG. 7;

FIG. 21 is a flow chart conceptually showing patterned-light illuminated image pick-up processing as a patterned-light illuminated image pick-up processing sub routine;

FIG. 22 is a flow chart conceptually showing a three-dimensional measurement processing sub routine in FIG. 15;

FIG. 23 is a flow chart conceptually showing a coded image generating program in FIG. 22;

FIG. 24 is a flow chart conceptually showing a synthesized program of a code edge in FIG. 22;

FIG. 25 is a flow chart conceptually showing a selection program of a code edge in FIG. 24;

FIG. 26 is a conceptual view of a synthesized code edge coordinates storing region in a code edge coordinates storing part shown in FIG. 7; and

FIG. 27 is a flow chart conceptually showing a step depicted in FIG. 15 as a three-dimensional shape-and color-detection-result generation sub routine.

### DETAILED DESCRIPTION OF THE INVENTION

Hereinafter, preferred embodiments of the present invention are further explained in detail in conjunction with attached drawings. Here, in this embodiment, the explanation is made by taking the detection of three-dimensional shape using a space coding method as an example. However, it is needless to say that a light cutting method which uses simple parallel beam (slit-like beam) patterned light or a method which arranges a group of spot light beams having certain regularity, or a method which uses a patterned light in which brightness and darkness are arranged in a mesh form is also applicable to the detection of the three-dimensional shape.

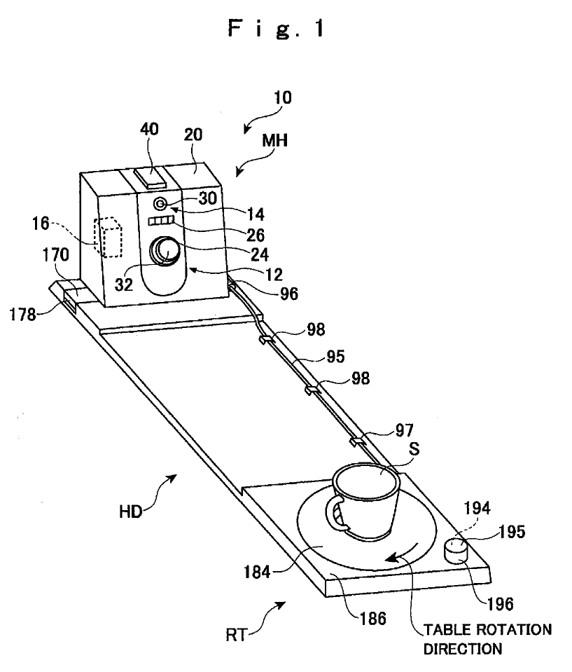

FIG. 1 is a perspective view showing the exterior of a three-dimensional shape detection device 10 which is constructed according to a first illustrative embodiment of the present invention. This three-dimensional shape detection device 10 includes a projection part 12 described later which time-sequentially projects plural kinds of respective patterned lights in which the brightness and the darkness are alternately arranged to an object S to be picked up, and an image pick-up part 14 described later which picks up an image of an object to be picked up to which the respective patterned lights from the projection part 12 are projected under a plurality of different exposure conditions. The three-dimensional shape detection device 10 is configured to perform signal processing for obtaining three-dimensional information and surface color information of the object S to be picked up based on a pick-up image result by the image pick-up part 14 using a computer.

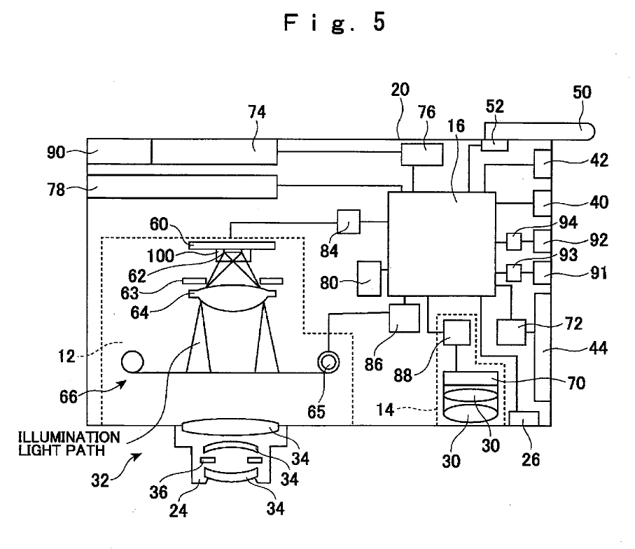

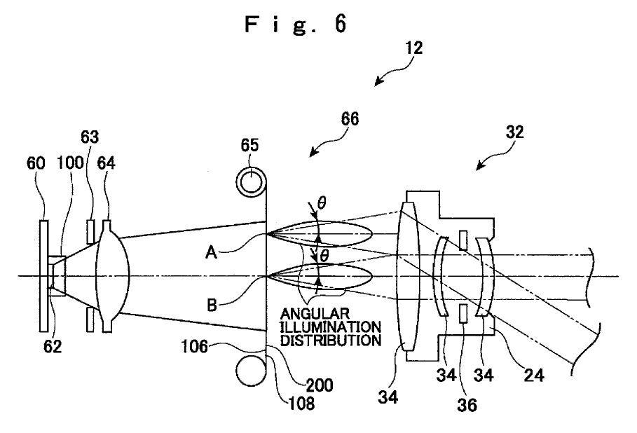

FIGS. 1 to 4 show the exterior structure of the three-dimensional shape detection device 10, while FIGS. 5 to 11 show the interior structure of the three-dimensional shape detection device 10. The exterior structure will be described below first and, thereafter, the interior structure will be described.

As shown in FIG. 1, the three-dimensional shape detection device 10 is configured to include a measurement head MH and a pedestal portion HD.

The measurement head MH is provided for use in optically picking up an image of the object S to be picked up and for measuring the three-dimensional shape and the surface-color of the object S to be picked up based on the pick-up image result. The pedestal portion HD is configured to be capable of mounting the measurement head MH and the object S to be picked up thereon. That is, the pedestal portion HD forms a measurement head mounting portion for mounting the measurement head MH in a region defined at one end thereof, and mounts a turntable RT which constitutes a mounting base for mounting the object S to be picked up thereon at another end thereof. The turntable part RT is provided to allow the indexing rotation of the object S to be picked up with respect to the measurement head MH, which enables the measurement head MH to pick up the image of the object S to be picked up per each indexing rotation of the object S to be picked up, to thereby allow the object S to be picked up in a manner that an overall area of an exterior surface of the object S to be picked up is divided into a plurality of sub-areas.

The object S to be picked up is picked up per each sub-area, resulting in the acquisition of a plurality of sub-images of the object S to be picked up. A three-dimensional shape is obtained by processing the plurality of sub-images obtained in this manner. The three-dimensional shapes obtained from the respective sub-images are combined into a single stitched image. The surface-color information that has been obtained for the identical object S to be picked up is mapped onto the 3-D stitched shape, to thereby generate a stitched texture image for the object S to be picked up.

As shown in FIG. 1, the measurement head MH is configured to include a projection part 12 adapted to project the patterned light onto the object S to be picked up, an image pick-up part 14 adapted to pick up the image of the object S to be picked up, and a processing part 16 adapted to perform the signal processing for obtaining the 3-D information and the surface color information of the object S to be picked up. The projection part 12, the image pick-up part 14 and the processing part 16 are all attached to a casing 20 of the measurement head MH, the casing 20 being generally in the form of a rectangular parallelepiped body.

As shown in FIG. 1, on the casing 20, there are mounted a lens barrel 24 and a flash light 26 in a position allowing each one of the lens barrel 24 and the flash light 26 to be exposed partly at the front face of the casing 20. On this casing 20, an image-pick-up optical system 30 is also mounted which constitutes a part of the image pick-up part 14, in a position allowing a portion of the lenses of the image-pick-up optical system 30 to be exposed at the front face of the casing 20. The image-pick-up optical system 30 receives, at an exposed portion of the image-pick-up optical system 30, imaging light indicative of the object S to be picked up.

The lens barrel 24, as shown in FIG. 1, is protruded from the front face of the casing 20, while including therein, as shown in FIG. 5, a projection optical system 32 which constitutes a part of the projection part 12. The projection optical system 32 is configured to include a plurality of projection lenses 34 and an aperture stop 36.

This lens barrel 24 holds the projection optical system 32 entirely movably for focus adjustment, and additionally protects the projection optical system 32 from being damaged. There is exposed at an exposed end face of the lens barrel 24, an outermost one of the plurality of projection lenses 34. The projection optical system 32 projects the patterned light from the outermost one of projection lens 34 toward the object S to be picked up.

The flash light 26, which acts as a light source to emit light to compensate for the shortage of light, is constructed with a discharge tube filled with Xe gas, for example. Thus, this flash light 26 can be reused with repeated electric discharges of a capacitor (not shown) built in the casing 20.

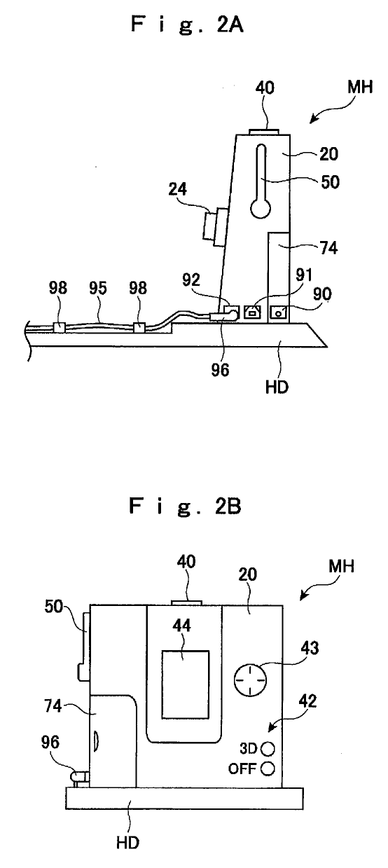

As shown in FIG. 1, a release button switch 40 is mounted on an upper surface of the casing 20. As shown in FIG. 2B, there are also mounted on a rear surface of the casing 20, a mode selection switch 42 (which is comprised of two buttons in an example shown in FIG. 2B), a four-directional cursor key (cruciform key) 43 and a monitor LCD 44. The mode selection switch 42 and the four-directional cursor key 43 respectively constitute an example of a function button switch.

The release button switch 40 is manipulated by a user to activate the three-dimensional shape detection device 10. This release button switch 40 is constituted of a two-phase pushbutton type switch allowing this release button switch 40 to issue different commands between when the operational state of the user (pushed state of the user) is in a “half-pushed state” and when in a “fully-pushed state.” The operational state of the release button switch 40 is monitored by the processing part 16. Upon detection of the “half-pushed state” of the release button switch 40 by the processing part 16, well-known features of auto-focus (AF) and auto-exposure (AE) start to automatically adjust the lens focus, the aperture stop and the shutter speed. In contrast, upon detection of the “fully-pushed state” of the release button switch 40 by the processing part 16, operations such as pick-up processing start.

The mode selection switches 42 are manipulated by a user to set a current operational mode of the three-dimensional shape detection device 10 as one of various kinds of operational modes including a 3-D measurement mode (denoted as “3D” in FIG. 2B) and an OFF mode (denoted as “OFF” in FIG. 2B), all of which will be described later. The operational state of the mode selection switches 42 is monitored by the processing part 16, and, upon detection of a current operational state of the mode selection switches 42 by the processing part 16, desired processing is performed in the three-dimensional shape detection device 10 in an operational mode corresponding to the detected operational state of the mode selection switches 42.

The monitoring LCD 44, which is configured with a liquid crystal display (LCD) being employed, displays desired images to a user in response to reception of an image signal from the processing part 16. This monitoring LCD 44 displays images indicative of the detected result of the three-dimensional shape of the object S to be picked up (stereoscopic-image) or the like, for example.

As shown in FIG. 2A and FIG. 2B, an antenna 50 acting as an RF (Radio-Frequency) interface is also mounted on the casing 20. The antenna 50 is, as shown in FIG. 5, connected to an RF driver 52. This antenna 50 transmits data or the like indicative of the object S to be picked up in the form of a stereoscopic image to an external interface (not shown) via the RF driver 25 by wireless.

Then, the structure employed for allowing the measurement head MH to be detachably mounted on the pedestal portion HD is explained by referring to FIG. 1 to FIG. 3.

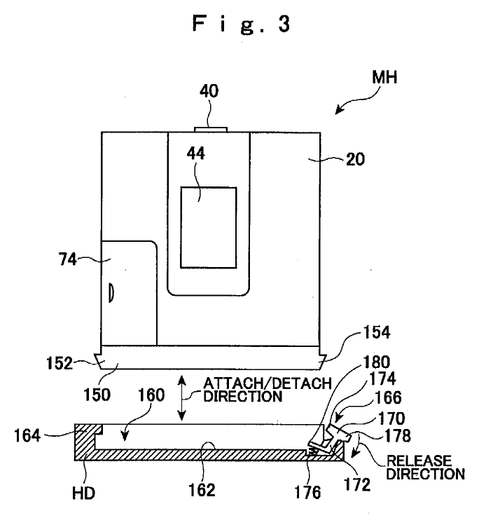

The measurement head MH is mounted on the pedestal portion HD due to mechanical engagement with the upper surface of one end of the pedestal portion HD. As shown in FIG. 3, for achieving the mechanical engagement, a head-seated portion 150 is formed on the lower end portion of the measurement head MH at which the measurement head MH is engaged with the pedestal portion HD. This head-seated portion 150 has first and second engagement pawls 152 and 154 which act as a pair of male engagement portions.

As shown in FIG. 3, these first and second engagement pawls 152 and 154 are formed at a pair of positions, respectively, which are spaced-apart from each other in the lateral direction of the measurement head MH, that is, in the widthwise direction of the pedestal portion HD, such that the first and second engagement pawls 152 and 154 extend in the longitudinal direction of the measurement head MH, that is, in the longitudinal direction of the pedestal portion HD. In this embodiment, positions of these first and second engagement pawls 152 and 154 have been each selected so as to maximize the distance therebetween for maximizing the firmness with which the measurement head MH is fixedly attached to the pedestal portion HD.

As shown in FIG. 3, there is formed, at the pedestal portion HD, a head receiving portion 160 which fixedly receives the head-seated portion 150 due to the mechanical engagement of the head receiving portion 160 with the head-seated portion 150. The head receiving portion 160 includes a head-base seated air-gap 162 into which the head-seated portion 150 is fitted, and also includes first and second pawl-abutment portions 164 and 166 acting as a pair of female engagement portions which are engaged with the first and second engagement pawls 152 and 154 of the measurement head MH respectively.

The first pawl-abutment portion 164 is a fixed pawl-abutment portion which is engaged with the corresponding first engagement pawl 152, to inhibit the measurement head MH from being disengaged from the pedestal portion HD in a direction perpendicular to the upper surface thereof. On the other hand, the second pawl-abutment portion 166 is a movable pawl-abutment portion which is displaceable between (a) an engagement position in which the second pawl-abutment portion 166 is engaged with the corresponding second engagement pawl 154 to inhibit the measurement head MH from being disengaged from the pedestal portion HD in a direction perpendicular to the upper surface thereof; and (b) a release position in which the second pawl-abutment portion 166 is disengaged from the corresponding second engagement pawl 154 to permit the measurement head MH to be disengaged from the pedestal portion HD in a direction perpendicular to the upper surface thereof.

An example of the second pawl-abutment portion 166 includes a pivot member 170 pivotable about the pivot axis extending in the longitudinal direction of the pedestal portion HD (a direction perpendicular to a plane of rotation in which the measurement head MH is rotated or tilted relative to the pedestal portion HD for allowing engagement thereto and disengagement therefrom).

The pivot member 170 is pivotably mounted on the pedestal portion HD via a joint 172 having an axis coaxial with the pivot axis of the pivot member 170. The pivot member 170 includes a movable engagement portion 174 which is mechanically engaged with the corresponding second engagement pawl 154 to inhibit the second engagement pawl 154 from being disengaged from the pivot member 170. The pivot member 170 is inevitably biased by a spring 176 acting as an elastic member in a direction allowing the movable engagement portion 174 to be engaged with the second engagement pawl 154 from above. In this embodiment, the pivot member 170 further includes an operating portion 178 which is to be pushed by the user for releasing the engagement by the second engagement pawl 154 and a leverage (lever) 180 which multiplies the elastic force of the spring 176 and transmits the multiplied force to the movable engagement portion 174.

Next, a user action required for attaching/detaching the measurement head MH with respect to the pedestal portion HD will be explained by referring to FIG. 3.

The user, for attaching the measurement head MH to the pedestal portion HD, pushes the operating portion 178 of the pivot member 170, against the elastic force of the spring 176, in a release direction allowing the movable engagement portion 174 to move from an engagement position to a release position. With the operating portion 178 being pushed, the user lowers the measurement head MH, together with a user action to rotate the measurement head MH generally in a vertical plane, so that the first engagement pawl 152 can enter a recess defined by the first pawl-abutment portion 164 and abutment thereon, while the head-seated portion 150 enters the head-base seated air-gap 162. Thereafter, the user releases the operating portion 178 from its pushed state, to thereby allow the pivotal movement of the pivot member 170 from the release position to the engagement position by virtue of the elastic restoring force of the spring 176, and then the movable engagement portion 174 moves toward the second engagement pawl 154 from above into engagement with and abutment on the second engagement pawl 154. As a result, the first engagement pawl 152 is inhibited from moving upwardly for disengagement from the first pawl-abutment portion 164, and additionally the second engagement pawl 154 is inhibited from moving upwardly for disengagement from the second pawl-abutment portion 166. Consequently, the measurement head MH is inhibited from being disengaged from the pedestal portion HD.

On the other hand, the user, for disengaging the measurement head MH from the pedestal portion HD, pushes the operating portion 178 of the pivot member 170, against the elastic force of the spring 176, in the same manner as the case explained above. With the operating portion 178 being pushed, the user raises the measurement head MH, together with a user action to rotate or tilt the measurement head MH generally in a vertical plane, so that the first engagement pawl 152 can escape from the first pawl-abutment portion 164, while the head-seated portion 150 is moving for escape from the head-base seated air-gap 162, whereby allowing the disengagement of the measurement head MH from the pedestal portion HD. Thereafter, the user releases the operating portion 178 from its pushed state, to thereby allow the return of the pivot member 170 from the release position to the engagement position by virtue of the elastic restoring force of the spring 176.

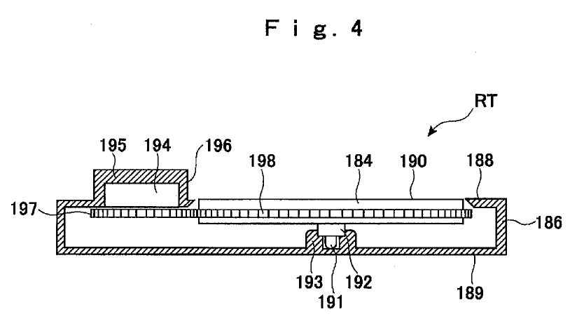

Next, the turntable part RT will be explained in more detail by referring to FIG. 4.

This turntable part RT includes a turntable 184 on which the object S to be picked up is to be placed, and a support frame 186 which rotatably supports the turntable 184. The support frame 186 is in the form of a thin hollow box defining its upper and lower plate portions 188 and 189, and at an opening of the upper plate portion 188, an upper surface of the turntable 184 is exposed. In this embodiment, the lower plate portion 189 of the support frame 186 acts also as the table base 132.

The upper surface of the turntable 184 is a support surface 190 on which the object S to be picked up is placed. On the other hand, a rotary shaft 191 coaxially extends from a lower face of the turntable 184, and is rotatably supported by the support frame 186 via a bearing 192. The bearing 192 is held by a bearing holder 193 formed in the support frame 186.

A table-mounted motor 194 for rotating the turntable 184 is mounted on the support frame 186. A motor box 195 accommodating the table-mounted motor 194 is formed in the support frame 186.

This motor box 195 is formed on the upper surface of the upper plate portion 188 of the support frame 186, so as to protrude upwardly from the upper surface. This motor box 195 defines its upper surface located above the upper surface of the turntable 184. The configuration allows a portion of the motor box 195 located above the upper surface of the turntable 184 to, when the object S to be picked up has a portion lying outside a silhouette of the turntable 184 obtained by hypothetically projecting the turntable 184 coaxially, abut the portion of the object S to be picked up as a result of rotational motion of the object S to be picked up together with the turntable 184, to thereby alter the orientation of the object S to be picked up.

Accordingly, the motor box 195 acts not only as a portion for housing the table-mounted motor 194 but also as a position guide portion 196 guiding the position at which the object S to be picked up is located on the turntable 184.

For transmission of the rotational motion of the table-mounted motor 194 to the turntable 184, a motor gear 197 is coaxially fixed to a rotary shaft of the table-mounted motor 194, and a table gear 198 mating with this motor gear 197 is coaxially fixed to the turntable 184. The selection of a smaller diameter of the motor gear 197 than that of the table gear 198, allows the rotational motion of the table gear 198 to be transmitted to the turntable 184 with the rotation speed being reduced.

In the alternative, the table-mounted motor 194 may be placed within the support frame 186 so as not to protrude from THE upper surface of the upper plate portion 188 of the support frame 186. In this embodiment, however, the table-mounted motor 194 is placed over an area of the upper surface of the upper plate portion 188 which area is outside an exposed surface of the turntable 184, and the placement would not suffer from any disadvantages, rather be more advantageous in reducing a thickness of the support frame 186.

Therefore, in this embodiment, the placement of the table-mounted motor 194 so as to protrude from the upper surface of the upper plate portion 188, provides the ability of more easily reducing a thickness of the support frame 186, in addition to the function of the position guide portion 196 explained above.

This three-dimensional shape detection device 10 is operated in accordance with a user-selected one of the plurality of different operational-modes. These modes include the 3-D measurement mode (hereinafter, referred to as “3-D mode”) and an OFF mode. The 3-D measurement mode is selected for the user to pick up the object S to be picked up, and to detect a stereoscopic shape of the object S to be picked up. The OFF mode is selected for the user to deactivate the operation of the three-dimensional shape detection device 10.

The image pick-up part 14 is configured to photograph the image of the object S to be picked up and, thereafter, to pick up the image of the object S to be picked up.

The projection part 12 is a unit for projecting the patterned light onto the object S to be picked up. As shown in FIG. 5 and FIG. 6, the projection part 12 includes therein: a substrate 60; an LED (Light Emitting Diode) unit 62 (for example, an LED unit having a single surface-emission-type LED element which emits light from a large emission surface); an illumination aperture stop 63; a light-source lens 64; a projection mechanism 66 having a mask motor (for example, in the form of a pulse motor), as a drive source 65 for feeding a roll of mask 200; and the projection optical system 32, all of which are disposed in series along a projection direction.

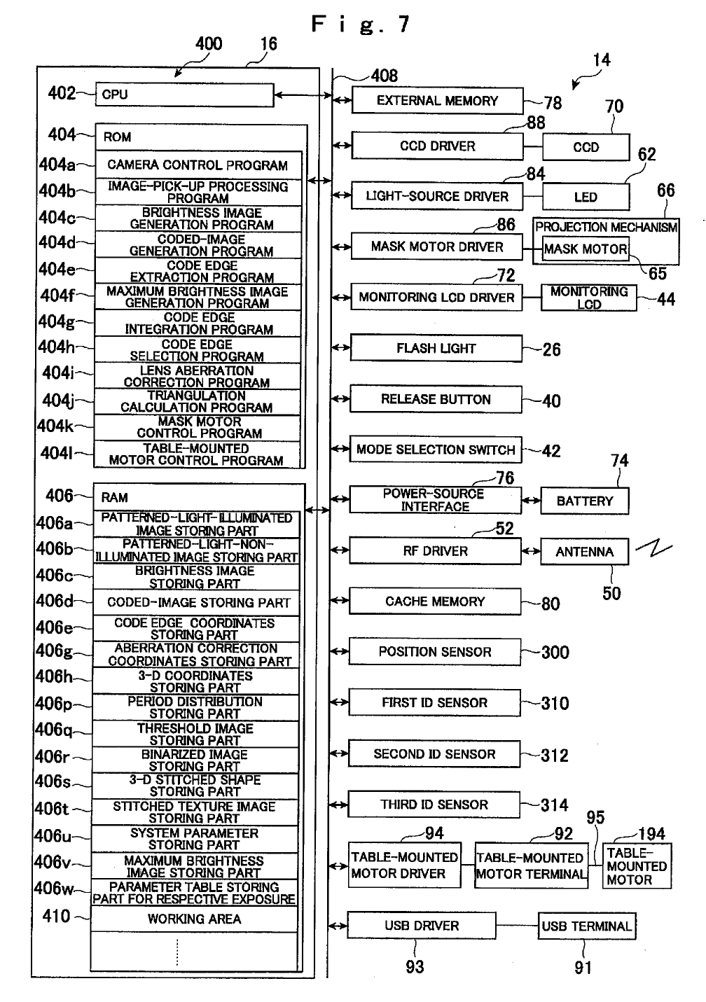

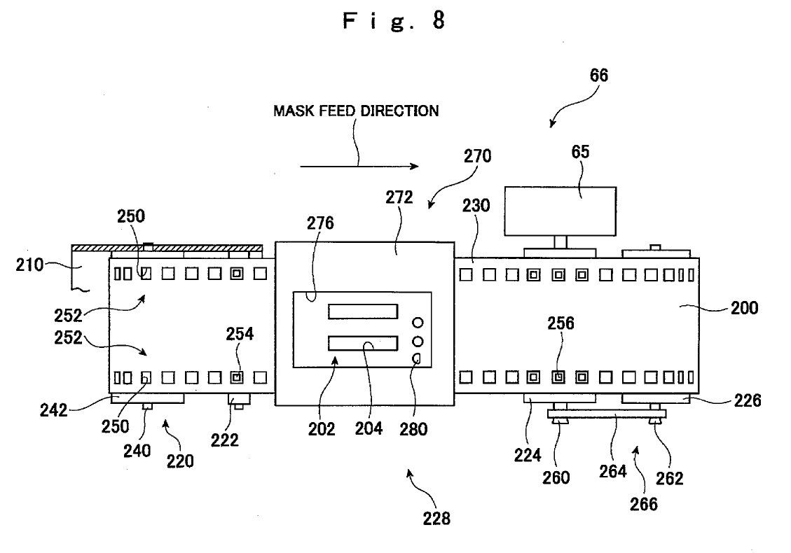

FIG. 6 shows in greater detail the substrate 60, the LED unit 62, the illumination aperture stop 63, the light-source lens 64, the mask 200, and the projection optical system 32, which are parts of the hardware configuration of the projection part 12. FIG. 7 shows in greater detail the software configurations and electrical connection relationship of the entire three-dimensional shape detection device 10 including the projection part 12. FIGS. 8 to 11 show in greater detail the projection mechanism 66 which is a part of the hardware configuration of the projection part 12.

The image pick-up part 14 is an image-pick-up module for picking up an image of the object S to be picked up. As shown in FIG. 5, this image pick-up part 14 includes therein the image-pick-up optical system 30 and a CCD (Charge Coupled Device) 70 which are disposed in series in the travel direction of incoming light representative of a real image of the object S to be picked up. The CCD 70 is configured to perform progressive scanning using an interline transfer technology. Further, the image pick-up part 14 includes therein a CCD driver 88 for controlling the CCD 70.

As shown in FIG. 5, the image-pick-up optical system 30 is constituted of a plurality of lenses. In operation, this image-pick-up optical system 30 adjusts the focal length and the aperture stop of the lenses automatically, using a well known auto-focus feature, resulting in the imaging of the externally incoming light on the CCD 70.

The CCD 70 is configured with a matrix array of photo-electric conversion elements such as photodiode elements. In operation, this CCD 70 generates pixel-by-pixel signals indicative of an image focused onto the surface of this CCD 70 via the image-pick-up optical system 30, wherein the signals are indicative of colors and intensities of light forming the focused image. The generated signals, after conversion into digital data, are outputted to the processing part 16.

As shown in FIG. 7 in a block diagram, the processing part 16 is connected electrically to the flash light 26, the release button switch 40 and the mode selection switch 42, respectively. This processing part 16 is further connected electrically to the monitoring LCD 44 via a monitoring LCD driver 72, to the antenna 50 via the RE driver 52, and to a battery 74 via a power-source interface 76, respectively. The above-listed connected-components beginning with the flash light 26 are controlled by the processing part 16.

The processing part 16 is additionally connected electrically to an external memory 78, a cache memory 80, and the image pick-up part 14 which constitutes the image-pick-up module respectively. This processing part 16 is still additionally connected electrically to the LED unit 62 via a light-source driver motor driver 84, and to a mask motor 65 of the projection mechanism 66 via a mask motor driver 86, respectively. The above-listed connected-components beginning with the LED unit 62 are controlled by the processing part 16.

The external memory 78 is in the form of a removal flash-ROM which can store images picked up in a stereoscopic-image mode, and 3-D information (including the above-explained stitched texture image and 3-D stitched shape). A SD card or a Compact Flash (registered trademark) card may be used as the external memory 78.

The cache memory 80 is a memory device enabling high-speed reading and writing of data. In an exemplary application, the cache memory 80 is used for transferring images picked up in the digital-camera mode to the cache memory 80 at a high speed, and storing the transferred images in the external memory 78, after implementing desired image-processing in the processing part 16. A SDRAM or a DDRRAM may be used as the cache memory 80.

The power-source interface 76, the light-source driver 84, the mask motor driver 86 and the CCD driver 88 are constructed as ICs (Integrated Circuits) which control the battery 74, the LED unit 62, the mask motor 65 of the projection mechanism 66, and the CCD 70.

As shown in FIG. 2A, the measurement head MH is provided with an AC adapter terminal 90, a USB terminal 91 and a table-mounted motor terminal 92. As shown also in FIG. 5, the AC adapter terminal 90 is connected electrically to the battery 74, to thereby allow the three-dimensional shape detection device 10 to use an external power source for supplying alternating current as a power source. As shown in FIG. 5, the USB terminal 91 is connected to the processing part 16 via a USB driver 93. As shown in FIG. 5, the table-mounted motor terminal 92 is connected to the processing part 16 via a table motor driver 94.

As shown in FIG. 1, there is an electric line in the form of a harness 95 extending out from the table-mounted motor 194 of the turntable part RT. As shown in FIG. 2A, the harness 95 has an L-shaped plug 96 connected to the leading edge of the harness 95 for connection with the table-mounted motor terminal 92. The harness 95 acts as an electric line which allows a control signal and electric power to be supplied from the measurement head MH to the table-mounted motor 194. Accordingly, as shown in FIG. 7, the table-mounted motor 194 is connected with the processing part 16 via the table-mounted motor driver 94.

As shown in FIG. 1, a position of the harness 95 is defined by harness clips 97, 98 and 98 on a surface of the pedestal portion HD.

As explained above, the projection part 12, as shown in FIG. 6, includes therein the substrate 60, the LED unit 62, the illumination aperture stop 63, the light-source lens 64, the projection mechanism 66 and the projection optical system 32, all of which are disposed in series in a projection direction of the patterned light.

The substrate 60, owing to the attachment to the LED unit 62, provides electrical wirings between the substrate 60 and the LED unit 62. The substrate 60 may be fabricated using, for example, an aluminum-made substrate to which an insulating synthetic resin is applied and thereafter a conductive pattern is formed by electroless plating, or a single- or multi-layered substrate having a core in the form of a glass-epoxy base material. The LED unit 62 is a light source which emits umber-colored radiant light from a large area toward the projection mechanism 66, and which is accommodated in an LED casing 100.

As shown in FIG. 6, the illumination aperture stop 63 is provided for occluding an undesired portion of light emitted from the LED unit 62, to thereby direct only a desired portion of the light to the light-source lens 64. The light-source lens 64 is a lens which acts to converge radiant light emitted from the LED unit 62, and which is made of an optical resin typified by acrylic plastics.

In this embodiment, as shown in FIG. 6, the radiant light emitted from the LED unit 62 is efficiently converged or collected by the light-source lens 64, and light emitted from the LED unit 62, upon entry into the projection mechanism 66 generally at a right angle relative to a light-entrance surface 106 thereof, and finally, is emitted from a light-emitting surface 108 of the projection mechanism 66 in the form of radiant light, with enhanced directivity. In this regard, the light-source lens 64 acts as a collimator lens. FIG. 6 is a graph showing the angular illumination distribution (θ: half spread-angle at half maximum), for explanation of the directivity of light beam emitted from the light-emitting surface 108 at two selected points A and B spaced apart from each other on the light-emitting surface 108.

The projection optical system 32 includes a plurality of projection lenses 34 for directing or projecting incoming light from the projection mechanism 66, toward the object S to be picked up. The plurality of projection lenses 34 are arranged in a telecentric configuration formed by combining glass lens(es) and synthetic-resin lens(es). The telecentric configuration enables principle rays passing through the projection optical system 32 to travel in parallel to its optical axis on the entrance side, and to define the position of an input pupil at infinity.

As explained above, the projection optical system 32 has a telecentric characteristic featured by an entrance numerical-aperture (NA) on the order of 0.1. An available optical path in the projection optical system 32, accordingly, is limited so as to allow light, only in the presence of an incidence angle of ±5 degrees from normal, to pass through an internal aperture stop 36 within the projection optical system 32. Therefore, in this embodiment, the telecentric configuration of the projection optical system 32 allows easy improvement of image quality, in cooperation with an additional configuration which allows light passing through the projection mechanism 66, only in the presence of an incident angle of ±5 degrees from normal, to be projected onto the projection optical system 32.

Then, the projection mechanism 66 as a hardware constituent of the projection part 12 will be explained in more detail by referring to FIG. 8 to FIG. 11.

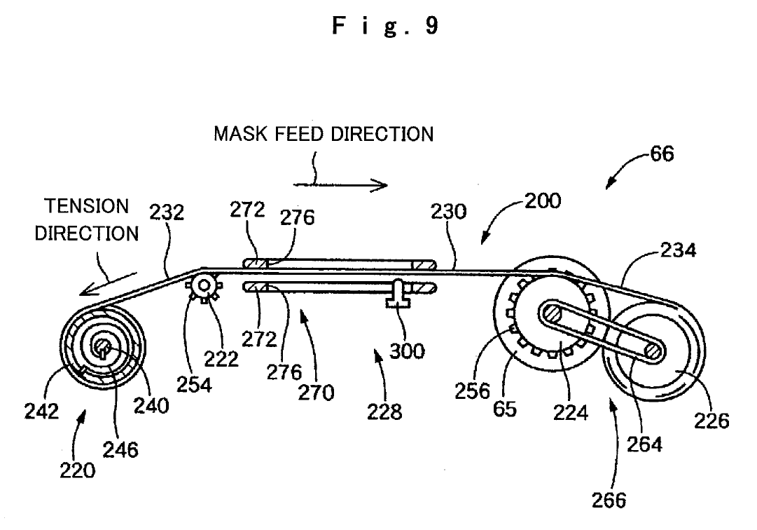

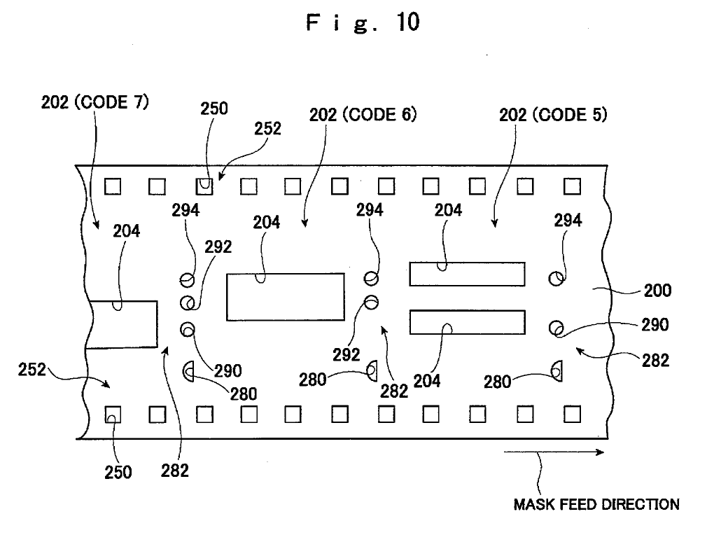

This projection mechanism 66 is provided for transforming the incoming light emitted from the LED unit 62 acting as the light source, into a selected one of a plurality of various patterned lights, to thereby sequentially project the thus-transformed patterned lights onto the object S to be picked up. FIG. 8 is a front view showing this projection mechanism 66, and FIG. 9 is a side view showing this projection mechanism 66 partly in section.

As shown in FIG. 8, this projection mechanism 66 is provided with the mask 200 which is sheet-shaped, extends in longitudinal direction thereof, and is fed in the longitudinal direction thereof by the mask motor 65.

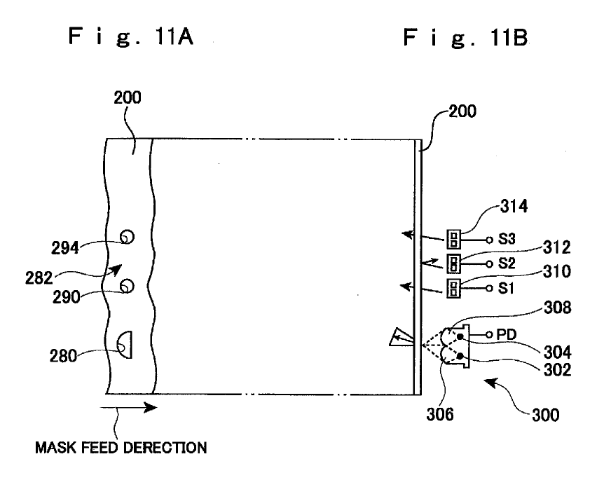

FIG. 10 is a front view showing in enlargement a fractional lengthwise portion of the mask 200. The mask 200 is assigned to a plurality of successive frames 202 in a linear array along the longitudinal direction of the mask 200, which frames 202 correspond to the aforementioned plurality of various patterned lights, respectively. As shown in FIG. 8, a successively-selected one of these frames 202 is located at an illuminated region by the aforementioned incoming light.

In this embodiment, in the 3-D mode, for picking up an image of the object S to be picked up, eight patterned lights are successively projected onto the object S to be picked up. FIG. 10 representatively shows one of the frames 202 for forming a patterned light whose pattern number PN is “5” (labeled “code 5” in FIG. 10), one of the frames 202 for forming a patterned light whose pattern number PN is “6” (labeled “code 6” in FIG. 10), and one of the frames 202 for forming a patterned light whose pattern number PN is “7” (labeled “code 7” in FIG. 10).

One through hole (air opening) 204 is formed in the mask 200 for each frame 202 in a state that the through hole 204 having a shape corresponding to a shape of the pattern light corresponding to each frame 202 penetrates the mask 200 in the thicknesswise direction. As shown in FIG. 10, for every frame 202, each through hole 204 is formed in a shape of a linear slit. in some frames Out of a plurality of frames 202, a plurality of through holes 204 are arranged for each frame 202 in a stripe shape.

Additionally, in this embodiment, each through hole 204 is oriented, in every frame 202, such that the through hole 204 extends in parallel to the longitudinal direction of the mask 200.

The mask 200 is flexible in a plane parallel to both the longitudinal and thickness directions of the mask 200. This mask 200 is made up of a thin metal-sheet. An example of the metal making up the mask 200 is an opaque elastic material, and an example of the material is stainless steel. The mask 200 has a thickness of 0.1 mm, for example.

In this embodiment, the mask 200 is fabricated by forming the plurality of through holes 204 in a stainless steel-sheet with the thickness of 0.1 mm with a micron order of accuracy, through wet etching of the stainless steel-sheet.

This mask 200 is featured by such elastic flexibility that allows the mask 200 which has been taken up by suitable rollers for storage as described below, to return to its original flat-plane shape when the mask 200 is unwound from the rollers.

As shown in FIG. 8, the projection mechanism 66 has a housing 210 which allows the mask 200 to be fed and to be held in a retractable manner. This housing 210 supports a supply roller 220 acting as a supply tool, a guide roller 222 acting as a guide tool, a feed roller 224 acting as a feed tool and a take-up roller 226 acting as a take-up tool, all of which have respective parallel axes. All the axes of the supply roller 220, the guide roller 222, the feed roller 224 and the take-up roller 226 extend in parallel to the width direction of the mask 200.

As shown in FIG. 9, the mask 200 has both ends thereof in longitudinal direction coupled to the supply roller 220 and the take-up roller 226 respectively. Further, the mask 200 is located between the supply roller 220 and the take-up roller 226, and is supported by the guide roller 222 near the supply roller 220 and the feed roller 224 near the take-up roller 226.

When the three-dimensional shape detection device 10 is not in use, the mask 200 is mainly wound around the supply roller 220 out of the supply roller 220 and the take-up roller 226 and, in this state, the mask 200 is accommodated in the three-dimensional shape detection device 10. That is, an unused portion of the mask 200 is wound around and received in the supply roller 220, and the supply roller 220 is a roller for receiving the unused portion of the mask 200 in a flexed state.

The unused portion of the mask 200, upon initiation of one cycle of picking up an image of the object S to be picked up, is fed toward the take-up roller 226 after being unwound from the supply roller 220 as a result of the normal (forward) rotation of the mask motor 65. The unused portion of the mask 200, after being used for picking up an image of the object S to be picked up, is taken up by and received in the take-up roller 226 as a used portion. That is, the take-up roller 226 is a roller for receiving the used portion of the mask 200 in a flexed state.

At the time that one cycle of picking up an image of the object S to be picked up is completed, the mask 200 is mainly wound around the take-up roller 226 out of the supply roller 220 and the take-up roller 2226 and, in this state, the mask 200 is accommodated within the three-dimensional shape detection device 10. Thereafter, in preparation for the next cycle of picking up an image, the mask 200 is mainly wound around the supply roller 220 out of the supply roller 220 and the take-up roller 226, as a result of the reverse rotation of the mask motor 65, whereby the mask 200 is accommodated in the three-dimensional shape detection device 10 with the mask 200 being wound around the supply roller 220.

As shown in FIG. 9, there is defined an illuminated position 228 which is located between the guide roller 222 and the feed roller 224, and at which the incoming light from the LED unit 62 illuminates the mask 200. A fractional lengthwise portion of the mask 200 which has both ends thereof respectively supported by the guide roller 222 and the feed roller 224 constitutes a rectilinear portion 230 which passes through the thus-defined illuminated position 228 in a direction perpendicular to the incoming light.

As shown in FIG. 9, in this embodiment, the mask 200 includes a portion 232 which has both ends thereof supported by the supply roller 220 and the guide roller 222 respectively (portion located on the left-hand side of the rectilinear portion in FIG. 9), and a portion 234 which has both ends thereof supported by the feed roller 224 and the take-up roller 226 respectively, (portion located on the right-hand side of the rectilinear portion in FIG. 9). These portions 232 and 234 are inclined with respect to the rectilinear portion 230 in the same direction. To reduce an unintended increase in the curvature of the rectilinear portion 230 which is induced from elastic flexes of the portions 232 and 234 with respect to the rectilinear portion 230, it is desirable to set the inclination angles of the portions 232 and 234 as small as possible. On the other hand, to downsize this projection mechanism 66 in the longitudinal direction of the mask 200, it is desirable to set angles of these portions 232 and 234 as large as possible.

As shown in FIG. 9, the mask 200 has both ends thereof in the longitudinal direction coupled to the supply roller 220 and the take-up roller 226, respectively.

The supply roller 220 is configured to include the shaft 240 fixed to the housing 210, and a roller portion 242 coaxially surrounding the shaft 240. The roller portion 242 is supported so as to be coaxially with and rotatable relative to the shaft 240. On end portion of the mask 200 is connected to the roller portion 242 and the mask 200 is wound around an outer circumferential surface of the roller portion 242 as a result of the rotational motion of the roller portion 242. Out of both rotational directions of the roller portion 242, the rotational direction along which the mask 200 is wound around the roller portion 242 is a return rotational direction and the other rotational direction is a feed rotational direction along which the mask 200 is unwound from the roller portion 242.

The roller portion 242 is engaged with a spring 246 acting as a biasing member and hence, the roller portion 242 is constantly biased in the return direction of rotation. The spring 246 is used such that, as shown in FIG. 9, for example, the spring 246 is engaged with the roller portion 242 acting as a movable member and the shaft 240 acting as a stationary member located within a radial clearance left between the roller portion 242 and the shaft 240. As shown in FIG. 9, for example, the spring 246 is formed as a leaf spring which is wound around the outer circumferential surface of the shaft 240. The elastic force of the spring 246 allows the mask 200 to be tensioned in its longitudinal direction.

As shown in FIGS. 8 and 10, the mask 200 is configured to have perforation areas 252, 252 formed at both lateral edges of the mask 200, respectively. In each perforation area 252, a plurality of feed holes 250 are formed in a linear array along the length of the mask 200. The guide roller 222 and the feed roller 224 have a plurality of teeth 254 and a plurality of teeth 256 respectively. The respective tooth 254, 256 penetrate through the respective feed holes 250 for engagement therewith. In this embodiment, as shown in FIG. 9, for both the guide roller 222 and the feed roller 224, the plurality of teeth 254 and 256 are arrayed at equal intervals on the outer circumferential surfaces of the guide roller 222 and the feed roller 224, respectively.

The guide roller 222 is a free roller, while the feed roller 224 is a driven roller driven by the mask motor 65. As shown in FIG. 8, in this embodiment, the mask motor 65 is coaxially coupled to the feed roller 224 which is driven for rotation by the mask motor 65. One of both directions of rotation of the feed roller 224 in which the mask 200 is unwound from the supply roller 220 is a feed direction of rotation, while the other in which the mask 200 is wound onto the supply roller 220 is a return direction of rotation.

As shown in FIG. 9, the mask motor 65 has the function of rotating the feed roller 224 and the function of rotating the take-up roller 226 in synchronization with the feed roller 224. To this end, the mask motor 65 is configured to perform a selected one of a normal rotation in which the mask 200 is taken up by the take-up roller 226, with the mask 200 being fed, and a reverse rotation in which the mask 200 is unwound from the take-up roller 226, with the mask 200 being supplied to the supply roller 220.

As shown in FIG. 8, in this embodiment, a drive pulley 260 is formed as a rotating body which is rotated coaxially and integrally with the feed roller 224 and the mask motor 65, and a driven pulley 262 is formed as a rotating body which is rotated coaxially and integrally with the take-up roller 262. Around both pulleys 260 and 262, a belt 264 acting as a power transmissive medium is wound. The thus-configured transmission mechanism 266 transmits the rotational force of the mask motor 65 to the take-up roller 226.

As shown in FIGS. 8 and 9, the projection mechanism 66 is provided with a mask guide 270 disposed at the illuminated position 228. The mask guide 270 is provided for guiding the rectilinear portion 230 of the mask 200 for feeding.

In this embodiment, the mask guide 270 is structured to sandwich the rectilinear portion 230 of the mask 200 from both sides of the rectilinear portion 230 in thicknesswise direction. More specifically, the mask guide 270 includes a pair of guide plates 272 and 272 oppositely facing with each other with the rectilinear portion 230 of the mask 200 being sandwiched therebetween. This mask guide 270 holds the mask 200 so as to allow the sliding motion of the mask 200 in the longitudinal direction while minimizing the deformation of the mask 200 in the widthwise direction.

Each guide plate 272 is configured to have a window 276 which is formed through each guide plate 272 in thicknesswise direction. This window 276 is, in the same manner as the through holes 204 formed in the mask 200 as an air-opening. Only a portion of the incoming light emitted from the LED unit 62 which passes through the window 276 is projected onto the mask 200.

As shown in FIG. 10, position reference holes 280 and ID hole regions 282 are formed in the mask 200 such that, for each frame 202 of the mask 200, the corresponding one of the position reference holes 280 and the corresponding one of the ID hole regions 282 are arranged in parallel along the widthwise direction of the mask 200. The position reference holes 280 and the ID hole regions 282 are respectively formed in the mask 200 in the form of a through hole (air opening). The position reference holes 280 are provided for optically detecting a state that one of the frames 202 is located just at the illuminated position 228. On the other hand, the ID hole regions 282 are provided for optically identifying the ID of the one frame 202 located at the illuminated portion 228, namely, the pattern number “PN”.

In this embodiment, each ID hole region 282 distinguishes the corresponding one of the eight frames 202, that is, the corresponding one of the eight patterned lights using information indicated by three-bit data. To this end, for each frame 202, the ID holes 290, 292, 295 whose maximum number is three are formed in the corresponding ID hole region 282.

As shown in FIG. 11, the projection mechanism 66 includes, for optically detecting the position reference holes 280, a position sensor 300 at a position which agrees with the position reference holes 280 with respect to the widthwise direction of the mask 200. In this embodiment, for the position sensor 300 to detect the position reference holes 280 with increased position accuracy, the position sensor 300 emits a focused beam toward the mask 200, and receives a focused beam reflected from the mask 200.

To this end, the position sensor 300 includes an LED (Light Emitting Diode) 302 acting as a light-emitting element, a photo diode (hereinafter, referred to as “PD”) 304 acting as a light-receiving element, an LED lens 306 acting as a light-collecting element for the LED 302, and a PD lens 308 acting as a light-collecting element for the PD 304. This position sensor 300, as shown in FIG. 7, is electrically connected to the processing part 16.

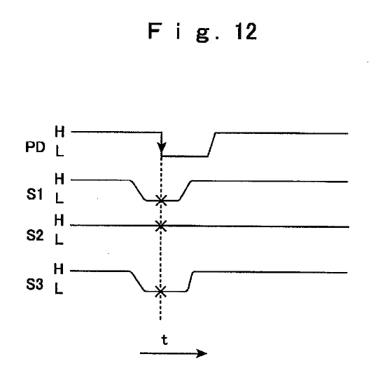

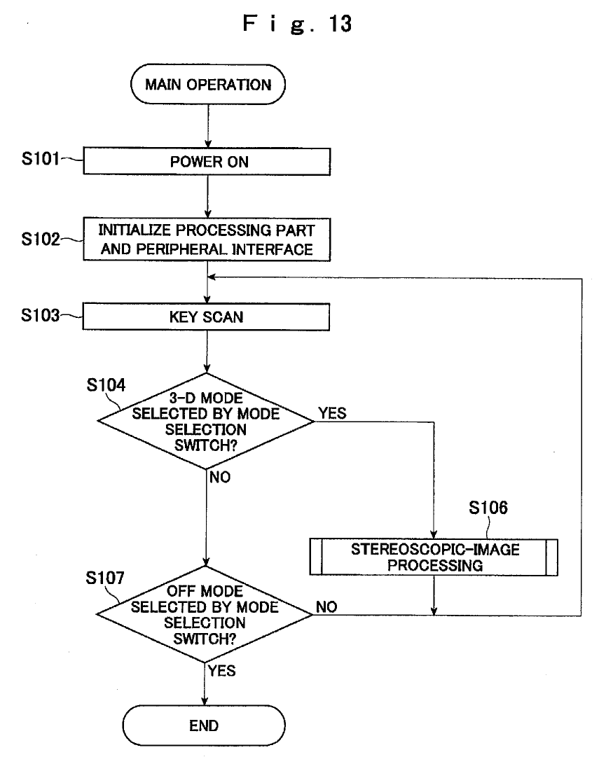

The PD 304 outputs a signal PD which varies in level depending on whether or not the PD 304 has received the reflected light from the mask 200. More specifically, as shown in a timing chart in FIG. 12, the signal PD is changed such that the signal PD becomes high when none of positional reference holes 280 face the position sensor 300 so that light from the position sensor 300 is reflected on the mask 200 and is incident on the position sensor 300. On the other hand, the signal PD becomes high when any one of the positional reference holes 280 face the position sensor 300 so that the light passes through the position reference hole 280 and is not incident on the position sensor 300.

The LED lens 306 has the ability of collecting light from the LED 302 and emitting the collected light to the mask 200. The PD lens 308 has the ability of collecting reflected light from the mask 200 and emitting the collected reflected light toward the PD 304. The LED lens 306 and the PD lens 308 allow the positions of the individual position reference holes 280 and therefore the positions of the individual frames 202, to be detected with high accuracy.

As shown in FIG. 11, the projection mechanism 66 additionally includes first to third ID sensors 310, 312 and 314 for optically detecting the ID holes 290, 292 and 294, respectively. The first to third ID sensors 310, 312 and 314 are disposed at positions coincident with those of the three ID holes 290, 292 and 294, respectively, with respect to the widthwise direction of the mask 200. Each ID sensor 310, 312 and 314 includes a light-emitting element which emits light toward an ID hole region 282 and a light-receiving element which receives the reflected light from the ID hole region 282.

The three light-receiving elements included in the first to third ID sensors 310, 312 and 314 are adapted to output signals as signals S1 to S3, respectively, each indicative of the presence/absence of the reflected light from the ID hole regions 282. Each signal S1, S2, S3 varies in level as with the signal PD described above. As shown in FIG. 7, each of first to third ID sensors is electrically connected to the processing part 16, as with the position sensor 300.

FIG. 12 is a timing chart showing how the signal PD and the signals S1 to S3 vary in synchronization with one another, by way of example. In the processing part 16, as will be described in more detail later, using a phenomenon that the signal PD is changed from high level to low level when any one of the position reference holes 280 faces the position sensor 300 during the feeding of the mask 200 due to driving of the mask motor 65 as a trigger, the signals S1 to S3 are sampled by the first to third ID sensors 310, 312 and 314 respectively.

In an example of the mask 200 shown in FIG. 11, the signals S1 and S3 change from high to low level as a result of the first and third ID sensors 310 and 314 being brought to face the ID holes 290, 294, respectively, while the signal S2 held high in level because the second ID sensor 312 does not face the ID hole 292. The ID of one of the frames 202 which has been detected by the position sensor 300, namely, the pattern number “PN” is detected using the combination of the levels of the sampled signals S1 to S3.

In FIG. 7, the electric configuration of the three-dimensional shape detection device 10 is shown in a block diagram. The processing part 16 is configured to include as a major component a computer 400 which is constructed to incorporate therein a CPU 402, a ROM 404, a RAM 406 and a bus 408.

The CPU 402 executes programs stored in the ROM 404 while using the RAM 406, thereby performing various sets of processing such as the detection of the status of the release button switch 40, the retrieval of image data from the image pick-up part 14, the transfer and storage of the retrieved image-data or the detection of the status of the mode selection switch 42.

The ROM 404 has stored therein a camera control program 404a, an image-pick-up processing program 404b, a brightness image generation program 404c, a coded-image generation program 404d, a code edge extraction program 404e, a maximum brightness image generation program 404f, a code edge integration program 404g, a code edge selection program 404h, a lens aberrations correction program 404i, a triangulation calculation program 404j, a mask motor control program 404k and a table-mounted motor control program 404l.

The camera control program 404a is executed to perform the total control of the three-dimensional shape detection device 10, wherein the total control includes a main operation conceptually expressed in a form of a flow chart shown in FIG. 13.

The image-pick-up processing program 404b is executed as follows to detect a three-dimensional shape of the object S to be picked up. That is, the image-pick-up processing program 404b time-sequentially projects the plural kinds of patterned-lights respectively onto the object S to be picked up, picks up an image of the object S to be picked up to which the respective patterned lights are projected under the plurality of different exposure conditions thus acquiring a patterned-light illuminated image, and picks up an image of the object S to be picked up to which the respective patterned lights are not projected thus acquiring a patterned-light non-illuminated image.

The brightness image generation program 404c is executed to generate a plurality of brightness images respectively corresponding to a plurality of patterned-light illuminated images for the respective exposure conditions based on RGB values of individual pixels acquired for the same object S to be picked up by execution of the image-pick-up processing program 404b. That is, by executing the brightness image generation program 404c, the CPU 402 generates, as a brightness image generation unit, the plurality of brightness images in which the brightnesses of the respective pixels are calculated based on the respective patterned-light illuminated imaged picked up by the image pick-up part 14 for the plurality of respective different exposure conditions.

In this embodiment, a plurality of different patterned-lights is time-sequentially and successively projected onto the same object S to be picked up, and the image of the object S to be picked up is picked up each time each patterned-light is projected onto the object S to be picked up while changing the exposure condition of the image pick-up part 14, thereby acquiring the RGB values of individual pixels for each of the thus-obtained patterned-light illuminated images under a plurality of different conditions, eventually resulting in the generation of a plurality of brightness images having the same total-number as that of the patterned lights for the respective exposure conditions.

The coded-image generation program 404d is executed to generate coded images to which a space code is allocated for every pixel under the respective exposure conditions based on binarized images which are generated by applying threshold processing to the plurality of respective brightness-images generated as a result of the execution of the brightness image generation program 404c, That is, by executing the coded-image generation program 404d, the CPU 402, as a coded image generating unit, generates the coded images under respective exposure conditions to which the space code is allocated for every pixel by applying the threshold processing to the plurality of brightness-images using predetermined threshold values.

Described schematically, upon initiation of this coded-image generation program 404d, a representative one of the plurality of brightness images is selected which was obtained when the object S to be picked up was illuminated by one of the plurality of patterned lights that has the smallest pitch distance between adjacent pattered lines among those of the plurality of patterned lights. Further, variable distances between adjacent twos of the patterned lines in the representative brightness-image are calculated as spacings or periods, and the distribution of the calculated periods over the entire representative brightness-image is calculated as a period distribution.

Upon initiation of this coded-image generation program 404d, additionally, a local variable-size window is provided in common to the brightness images associated with different patterned lights, so as to have a size variable along the profile of the calculated period-distribution of the representative brightness-image, thereby filtering the entire representative brightness-image using the thus-provided variable-size window. The filtering is performed for calculating and determining local thresholds over the entire representative brightness-image, thereby generating a threshold image indicative of the distribution of the thus-determined thresholds. From the relation between the thus-generated threshold image and each of the different brightness-images, binarized images are generated on a patterned-light-by-patterned-light basis. The binarized image is generated for every exposure condition.

A technique of filtering the entire representative brightness-image using the thus-provided variable-size window for calculating local thresholds over the entire brightness-image, is disclosed in more detail in Japanese Patent Application No. 2004-285736 that was filed by the same applicant as that of the present application, the disclosure of which is herein incorporated by reference in its entirety.

The code edge extraction program 404e is executed to extract code edge coordinates which are code edge positions of the space codes for respective coded images with sub-pixel accuracy, by the use of both coded images generated by the execution of the coded-image generation program 404d for the respective exposure conditions and the brightness images generated by the execution of the brightness image generation program 404c for the respective exposure conditions. That is, by executing the code edge extraction program 404e, the CPU 402 performs, as a code edge extraction unit, the processing for extracting code edge positions of the space codes with respect to the respective coded images under the respective exposure conditions.

The maximum brightness image generation program 404f is executed for generating the maximum brightness image by detecting the maximum brightness values of the respective pixels for respective exposure conditions based on the plurality of brightness images generated by the execution of the brightness image generation program 404c. That is, by executing the maximum brightness image generation program 404f, the CPU 402 generates, as a maximum brightness image generation unit, the maximum brightness image by detecting the maximum brightness values of the respective pixels from the respective pick-up imaged picked up by the image pick-up part 14 for the respective exposure conditions. Here, a patterned-light trajectory extraction unit which extracts trajectories of the patterned lights from the patterned-light projected images picked up by the image pick-up part 14 is constituted of the brightness image generation unit and the coded image generation unit described above.

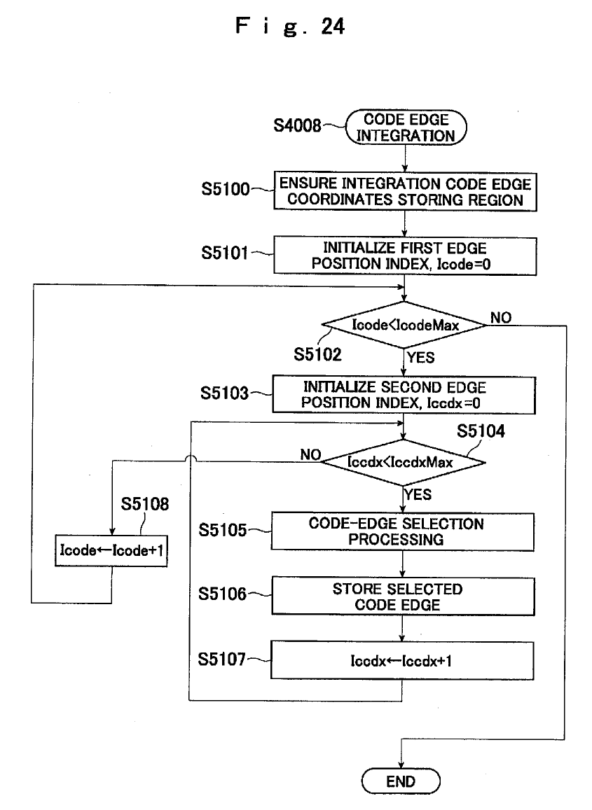

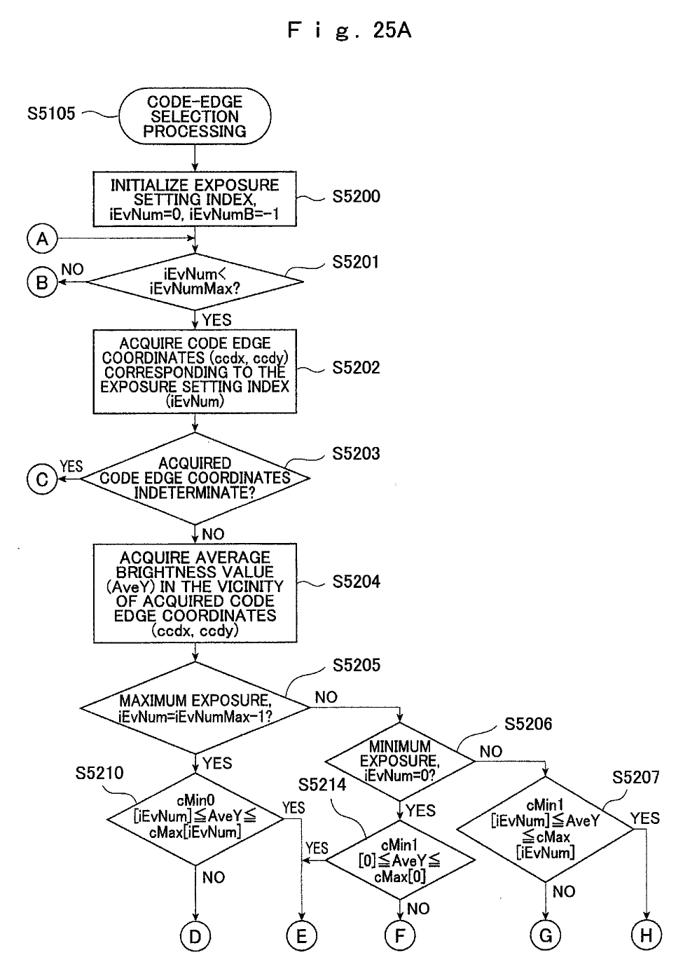

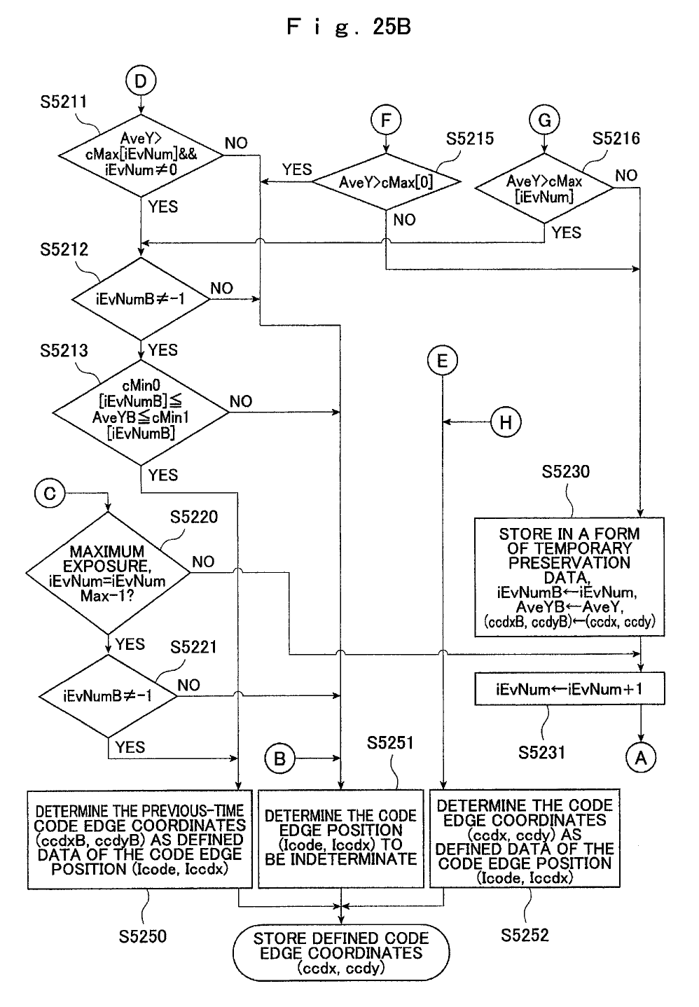

The code edge integration program 404g and the code edge selection program 404h are executed, based on the plurality of code edge positions for the respective exposure conditions extracted by executing the code edge extraction program 404c and the maximum brightness image generated by the execution of the maximum brightness image generation program 404f, for determining one code edge position for calculating the three-dimensional shape of the object S to be picked up. That is, by executing the code edge integration program 404g and the code edge selection program 404h, the CPU 402, as a code edge integration unit (pattern trajectory integration unit), determines one code edge position (pattern trajectory position) for calculating the three-dimensional shape of the object S to be picked up. The code edge integration program 404g and the code edge selection program 404h are conceptually expressed in a form of flow charts shown in FIG. 24 and FIG. 25.

The lens aberrations correction program 404i is executed to process the code edge position generated by the execution of the code edge integration program 404g and the code edge selection program 404h, for correction of aberrations or distortion due to the image-pick-up optical system 30.

The triangulation calculation program 404j is executed to calculate, from the code edge coordinates which have been aberrations-corrected by the execution of the lens aberrations correction program 404i, 3-D coordinates defined in a real space which correspond to the aberrations-corrected code edge coordinates.

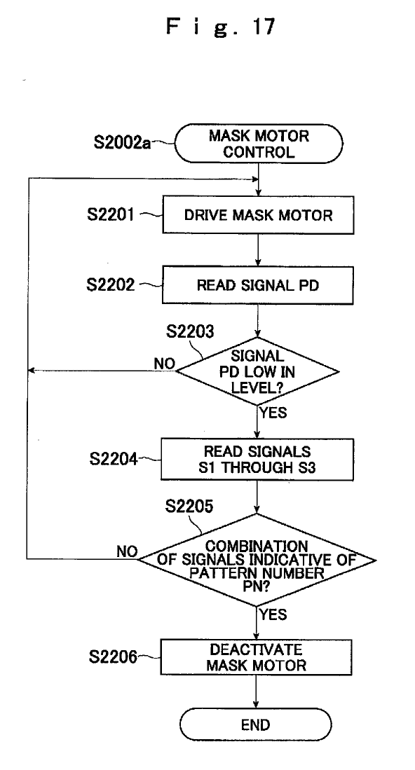

The mask motor control program 404k is executed to control the mask motor 65 for successively projecting a plurality of different patterned lights onto the object S to be picked up. The mask motor control program 404k is conceptually expressed in a form of a flow chart in FIG. 17.

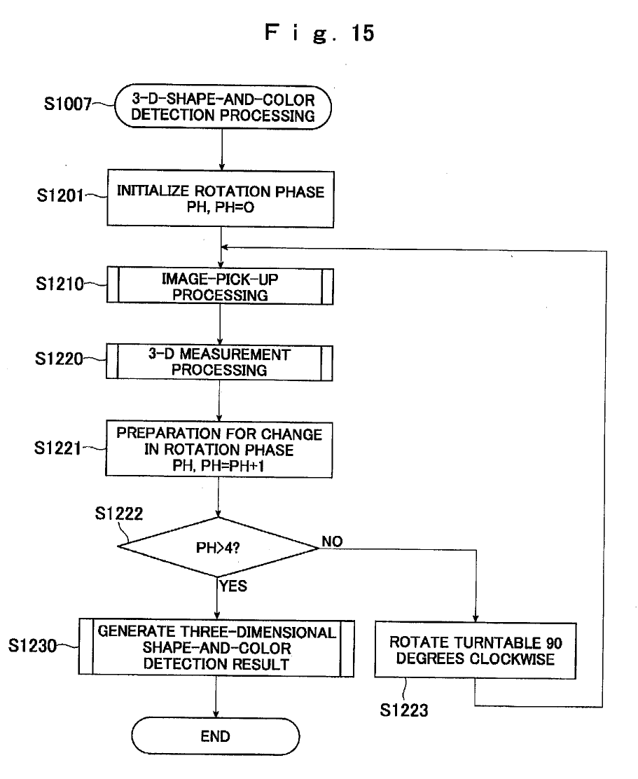

The table-mounted motor control program 404l is executed to control the table motor 194 for allowing indexing rotation of the turntable 184 together with the object S to be picked up. This table-mounted motor control program 404l is conceptually expressed along with other processing, in a form of a flow chart in FIG. 15.

In this embodiment, sequential projection of a series of the aforementioned patterned lights onto the object S to be picked up and sequential image-pick-up processings of the object S to be picked up are performed in combination each time the object S to be picked up is angularly indexed at equal intervals. More specifically, the object S to be picked up is angularly and intermittently indexed 90 degrees, and, at each indexing position, the sequential projection of a series of patterned lights and the sequential image-pick-up processings are performed for the object S to be picked up. As a result, the overall area of the exterior surface of the object S to be picked up is divided into four sub-areas, and three-dimensional shape information is acquired for the four sub-areas, respectively. The thus-acquired three-dimensional shape information, after are processed removal of overlapped portions therebetween, combined (stitched) together, whereby a single three-dimensional shape information corresponding to the object S to be picked up is generated as a 3-D stitched shape.

Additionally, in this embodiment, as a result of mapping of the surface color information previously measured for the same object S to be picked up onto the generated 3-D stitched shape, a stitched texture image is generated. Then, a series of 3-D input operations for the object S to be picked up is completed.

As shown in FIG. 7, the RAM 406 has memory areas assigned to the following: a patterned-light illuminated image storing part 406a; a patterned-light-non-illuminated image storing part 406b; a brightness image storing part 406c; a coded-image storing part 406d; a code edge coordinates storing part 406e; an aberration correction coordinates storing part 406g; a 3-D coordinates storing part 406h; a period distribution storing part 406p; a threshold image storing part 406q; a binarized image storing part 406r; a 3-D stitched shape storing part 406s; a stitched texture image storing part 406t; a system parameter storing part 406u; a maximum brightness image storing part 406v; a parameter table storing part 406w for respective exposures; and a working area 410.

The patterned-light illuminated image storing part 406a is used for storage of data indicative of a patterned-light illuminated image picked up as a result of the execution of the image-pick-up processing program 404b. The patterned-light-non-illuminated image storing part 406b is used for storage of data indicative of a patterned-light-non-illuminated image picked up as a result of the execution of the image-pick-up processing program 404b.

The brightness image storing part 406c is used for storage of data indicative of brightness images resulting from the execution of the brightness image generation program 404c. The coded-image storing part 406d is used for storage of data indicative of a coded image resulting from the execution of the coded-image generation program 404d. The code edge coordinates storing part 406e is for use in storing data indicative of code edge coordinates extracted with sub-pixel accuracy by the execution of the code edge extraction program 404e.

The aberration correction coordinates storing part 406g is used for storage of data indicative of the code edge coordinates processed for the aberrations correction by the execution of the lens aberrations correction program 404i. The 3-D coordinates storing part 406h is used for storage of data indicative of 3-D coordinates in the real space calculated by the execution of the triangulation calculation program 404j.

The period distribution storing part 406p, the threshold image storing part 406q and the binarized image storing part 406r are used for storage of data indicative of the period distribution, data indicative of the threshold image, and data indicative of the binarized images, respectively, all acquired by the execution of the coded-image generation program 404d.

The 3-D stitched shape storing part 406s is used for storage of the aforementioned 3-D stitched shape. The stitched texture image storing part 406t is used for storage of the aforementioned stitched texture image. The maximum brightness image storing part 406v is used for storage of the aforementioned maximum brightness image. Further, the system parameter storing part 406u is used for storage of the aforementioned system parameter.

The parameter table storing part 406w for respective exposures stores, as an exposure condition information storing part, information on the plurality of different exposure conditions for setting the exposure of the CCD 70 in the image pick-up part 14 as the parameter table for respective exposures. The parameter table for respective exposures includes a plurality of exposure time parameters for changing over the exposure time of the CCD 70 of the image pick-up part 14. Along with the execution of the image-pick-up processing program 404b, the plurality of exposure time parameters are sequentially set in the image pick-up part 14 so that the exposure time of the CCD 70 is changed over. In this embodiment, the explanation is made with respect to the constitution which uses the exposure time of the CCD as the exposure condition and changes over the exposure conditions based on the exposure time. However, this embodiment is not limited to such constitution. In the constitution which determines the exposure of the image pick-up part 14 using an optical member, the exposure conditions may be changed over by changing the degree of stop of a shutter.

The working area 410 temporarily stores data which the CPU 402 uses for an operation thereof.

Here, the system parameters stored in the system parameter storing part 406u is explained.

The three-dimensional-shape detection device 10 according to this embodiment uses an active-type three-dimensional image measuring method which determines one point of a three-dimensional space as an intersecting point of a plane and a straight line or an intersecting point of two straight lines. That is, patterned lights projected from the projection part at a predetermined position and a line of sight from the image pick-up part at a predetermined position are grasped as a plane and a straight line, an imaging optical system constituted of the projection part and the image pick-up part is formed as a model using system parameters including positions and postures of the projection part and the image pick-up part, and a three-dimensional shape is measured using the system parameters. The system parameters are parameters which are constituted of camera parameters and projector parameters and these parameters are explained specifically hereinafter.

The camera parameters are expressed as following 12 parameters (=3×4). These parameters include data such as a position, a posture, an angle of field and the like with respect to the image pick-up part. In other words, the parameters express a line of sight from the image pick-up part.

$$C = ( \begin{matrix}C 11 & C 12 & C 13 & C 14 \\ C 21 & C 22 & C 23 & C 24 \\ C 31 & C 32 & C 33 & C 34\end{matrix} )$$

Using these camera parameters, the relationship between the three-dimensional coordinates (X,Y,Z) of a real space and coordinates (ccdcx, ccdcy) of the image-pick-up coordinates system after correction of skewness aberration can be expressed by a following formula.

$$( \begin{matrix}Hc \times ccdcx \\ Hc \times ccdcy \\ Hc\end{matrix} ) = ( \begin{matrix}C 11 & C 12 & C 13 & C 14 \\ C 21 & C 22 & C 23 & C 24 \\ C 31 & C 32 & C 33 & C 34\end{matrix} ) ( \begin{matrix}X \\ Y \\ Z \\ 1\end{matrix} )$$

On the other hand, the projector parameters are expressed as following 8 parameters (=2×4). These parameters include data such as a position, a posture and the like with respect to the projection part. In other words, the project parameters express a plane formed of pattered lights.

$$P = ( \begin{matrix}P 11 & P 12 & P 13 & P 14 \\ P 21 & P 22 & P 23 & P 24\end{matrix} )$$

Using these projector parameters, the relationship between the three-dimensional coordinates (X,Y,Z) of a real space and the space code edge values code can be expressed by a following formula.

$$( \begin{matrix}X \\ Y \\ Z \\ 1\end{matrix} ) ( \begin{matrix}Hp \times code \\ Hp\end{matrix} ) = ( \begin{matrix}P 11 & P 12 & P 13 & P 14 \\ P 21 & P 22 & P 23 & P 24\end{matrix} )$$

Based on these camera parameters and projector parameters, the three-dimensional coordinates V=(X,Y,Z) of the real space of the object to be picked up can be obtained by a following formula.

$$F = Q \times V$$

$$V = {Q}^{- 1} \times F$$

$$F = ( \begin{matrix}C 34 * ccdcx - C 14 \\ C 34 * ccdcy - C 24 \\ P 24 * code - P 14\end{matrix} )$$

$$Q = ( \begin{matrix}C 11 - C 31 * ccdcx & C 12 - C 32 * ccdcx & C 13 - C 33 * ccdcx \\ C 21 - C 31 * ccdcy & C 22 - C 32 * ccdcy & C 23 - C 33 * ccdcy \\ P 11 - P 21 * code & P 12 - P 22 * code & P 13 - P 23 * ccdcx\end{matrix} )$$

$$V = ( \begin{matrix}X \\ Y \\ Z\end{matrix} )$$

The above-mentioned system parameters, that is, the camera parameters and the projector parameters are stored in the system parameter storing part 406u.

Referring to FIG. 13, the camera control program 404a will be described below. As a result of the execution of this program 404a by the computer 400, the aforementioned main operation is performed.

The main operation starts with step S101 to power on a power source including the battery 74, which is followed by step S102 to initialize the processing part 16, a peripheral interface or the like.

Subsequently, in step S103, key scanning is performed for monitoring the status of the mode selection switch 42, and then, in step S104, it is determined whether or not the 3-D mode is selected by the user through the mode selection switch 42. Thereafter, the processing advances to step S106 to perform stereoscopic-image processing described later in more detail, and subsequently, returns to step S103.

To the contrary, however, if the 3-D mode is not selected by the user through the operation of the mode selection switch 42, then the determination in step S104 becomes “NO,” and the processing advances to step S107 to make a determination as to whether or not the OFF mode is selected by the user through the mode selection switch 42. If so, then the determination in step S107 becomes “YES” and the main processing this time is immediately finished. If, however, the 3-D mode is not selected by the user through the mode selection switch 42, then the determination in step S106 becomes “NO” with return to step S103.

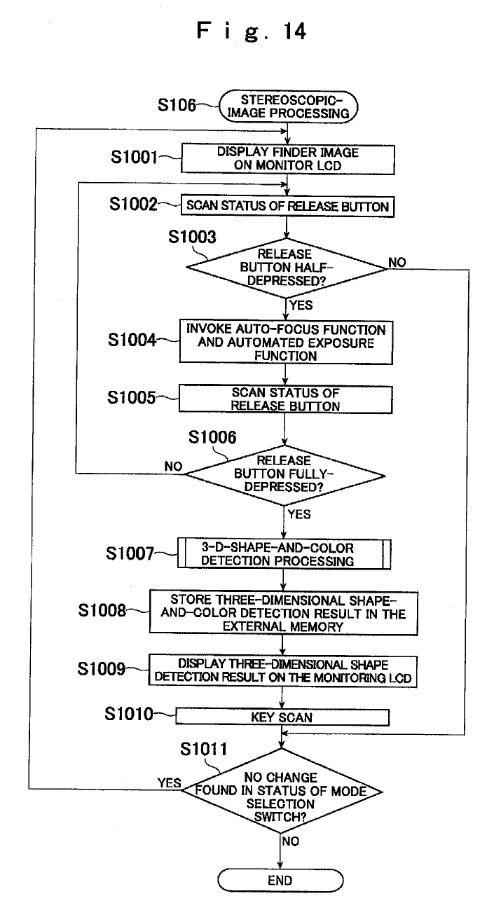

In FIG. 14, step S106 depicted in FIG. 13 is conceptually expressed in a form of a flow chart as a stereoscopic-image processing routine. As a result of the execution of this routine, stereoscopic-image processing is performed to detect the three-dimensional shape of the object S to be picked up as the stereoscopic image, and to display the thus-detected stereoscopic image. This stereoscopic-image processing is further performed to detect the surface color of the same object S to be picked up. A combination of the detected stereoscopic image and the detected surface color with their positions being in alignment with each other refers to a three-dimensional shape-and-color detection result.

This stereoscopic-image processing starts with step S1001 to display a finder image on the monitor LCD 44 exactly as an image which the user can view through the image-pick-up optical system 30. This enables the user to verify a picked up image (image-pick-up field) prior to a substantial image-pick-up stage, provided that the user views an image displayed on the monitoring LCD 44.

Next, in step S1002, the status of the release button switch 40 is scanned or monitored, and then, in step S1003, based on the result from the scan, it is determined whether or not the release button switch 40 has been half-pushed. If so, then the determination in step S1003 becomes “YES”, and the processing advances to step S1004 to invoke the auto-focus function (AF) and the automated exposure function (AE), thereby adjusting the lens focus and aperture and the shutter speed. If, in step S1003, it is determined that the release button switch 40 has not been brought into the half-pushed state, then the determination in step S1003 becomes “NO,” and the processing advances to step S1011. Here, the exposure conditions adjusted by the automatic exposure (AE) function generated in step S1004 is temporarily set in the working area 410 and are used at the time of picking up the patterned-light non-illuminated image described later.

Upon completion of step S1004, in step S1005, the status of the release button switch 40 is scanned again, and then, in step S1006, based on the result from the scan, it is determined whether or not the release button switch 40 has been fully-pushed. If not, the determination in step S1006 becomes “NO,” and the processing returns to step S1002.

If, however, the release button switch 40 has changed from the half-pushed state into the fully-pushed state, then the determination in step S1006 becomes “YES,” and the processing advances to step S1007 to perform 3-D-shape-and-color detection processing described later, thereby detecting the three-dimensional shape-and-color of the object S to be picked up.

Described schematically, a 3-D-shape-and-color detection result is generated as a result of the execution of the three-dimensional shape-and-color detection processing. In this regard, the term “3-D-shape-and-color detection result” is used herein to mean a set of vertex coordinates obtained by converting a plurality of space-code edge coordinates extracted from a space-coded image as described later, into 3-D coordinates, wherein shape-and-color information and polygon information are in association with each other per each vertex. The shape-and-color information is indicative of a combination of real space coordinates and RGB values. The polygon information is indicative of a combination of ones of a total number of vertexes which are to be coupled to one another for constructing a solid representative of the object S to be picked up in a three-dimensional manner.

Thereafter, in step S1008, the three-dimensional shape-and-color detection result is stored in the external memory 78, and then, in step S1009, the three-dimensional shape detection result is displayed on the monitoring LCD 44 as a 3-D computer-graphics image.

Next, in step S1010, the key scanning is performed in a similar manner to step S103 in FIG. 13. Subsequently, in step S1011, it is determined whether or not no change has been found in the status of the mode selection switch 42. If so, then the determination in step S1011 becomes “YES” and the processing returns to step S1001, and otherwise, the determination in step S1011 becomes “NO”, and this stereoscopic-image processing is finished.

The three-dimensional shape-and-color detection processing is performed in step S1007 shown in FIG. 14 to detect the three-dimensional shape of the object S to be picked up using a space-encoding technique.

In FIG. 15, step S1007 shown in FIG. 14 is conceptually expressed in a form of a flow chart as a three-dimensional shape-and-color detection processing routine. The three-dimensional shape-and-color detection processing routine incorporates therein a table-mounted motor control program 404l which is designed to incorporate steps S1201 and S1221 to S1223 depicted in FIG. 15.

The three-dimensional shape-and-color detection processing routine starts with step S1201 to make a zero initialization of a rotation phase PH of the turntable 184. In this embodiment, the turntable 184 stops four times per each rotation, and therefore, four discrete rotation phases PH are assigned to the turntable 184. More specifically, as the turntable 184 rotates, the value of the rotation phase PH of the turntable 184 varies discretely from “0” indicative of the initial rotation phase PH, “1” indicative of the next rotation phase PH, “2” indicative of the rotation phase PH followed by the rotation phase PH “1,” to “3” indicative of the final rotation phase PH.

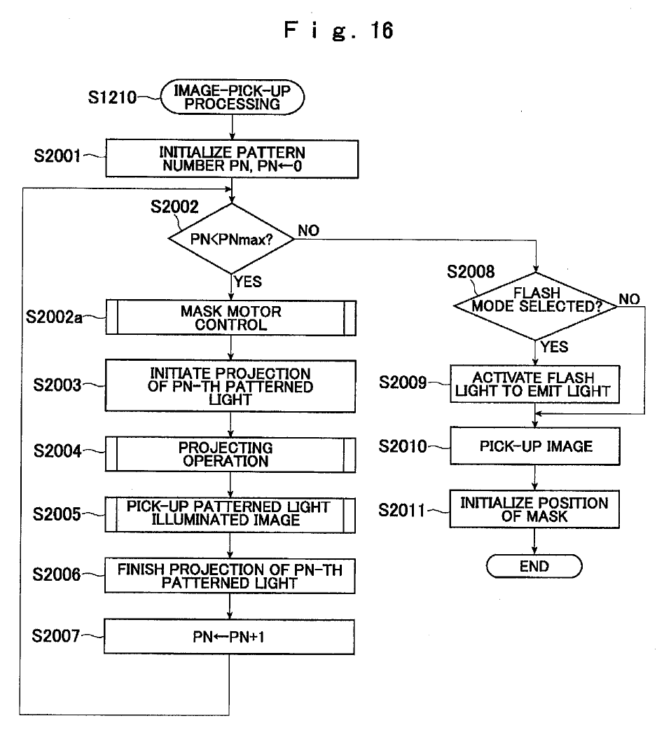

Next, in step S1210, an image-pick-up processing is implemented for the current rotation phase PH as a result of the execution of the image-pick-up processing program 404b. In the image-pick-up processing, the projection part 12 successively projects a plurality of striped patterns of light onto the object S to be picked up. Further, a plurality of patterned-light illuminated images for respective exposure conditions is acquired by respectively picking up an image of the object S to be picked up with the plural kinds of patterned lights being projected onto the object S to be picked up under a plurality of different exposure conditions, and one patterned-light-non-illuminated image is acquired by picking up an image of the same object S to be picked up with no patterned light being projected onto the object S to be picked up. This step S1210 will be described later in more detail by referring to FIG. 16.

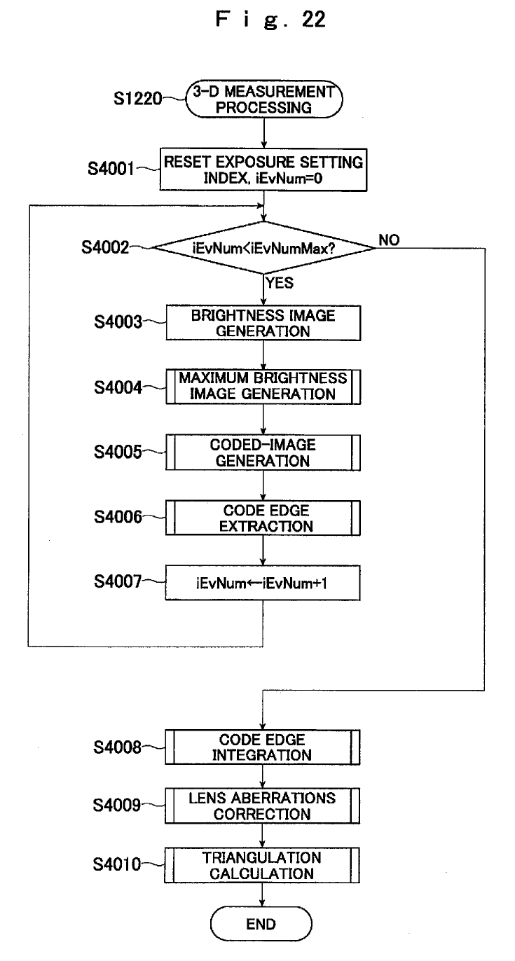

Upon completion of the image-pick-up processing, in step S1220, 3-D measurement processing is performed for the current rotation phase PH. Upon initiation of this 3-D measurement processing, the patterned-light illuminated images and the one patterned-light-non-illuminated image each picked up by the preceding image-pick-up processing are utilized to actually measure the three-dimensional shape of the object S to be picked up. This step S1220 will be described later in more detail by referring to FIG. 22.

Upon completion of the 3-D measurement processing, in step S1221, the rotation phase PH is incremented by 1 in preparation for a next image-pick-up processing. Subsequently, in step S1222, it is determined whether or not the current value of the rotation phase PH is greater than “4”, that is, whether or not all the sequential image-pick-up processings have been already completed for the object S to be picked up.

If the current value of the rotation phase PH is not greater than “4”, then the determination in step S1222 becomes “NO”, and the processing advances to step S1223 to transmit a drive signal required for rotating the turntable 184 by 90 degrees in a clockwise direction, to the table-mounted motor 194. As a result, the turntable 184 is rotated 90 degrees in a clockwise direction, thereby turning the object S to be picked up to a position in which one of the sub-areas of the object S to be picked up that has not been previously picked up faces the measurement head MH. Thereafter, steps S1210 and S1220 are executed, whereby the aforementioned sequential image-pick-up processings and the 3-D measurement processing are performed for the subsequent rotation phase PH.

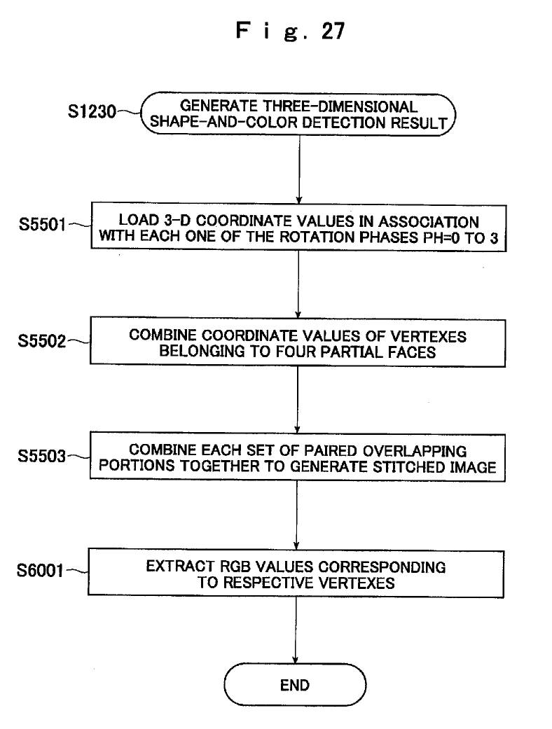

If, as a result of the execution of the loop of steps S1210 to S1223 a required number of times, the determination in step S1222 becomes “YES”, then the processing advances to step S1230 to generate the three-dimensional shape-and-color detection result by combining the three-dimensional shape and the surface-color both of which have been measured for the object S to be picked up. This step S1230 will be described in more detail later by referring to FIG. 27.

Upon generation of the three-dimensional shape-and-color detection result, the current cycle of the three-dimensional shape-and-color detection processing is terminated.

Referring to FIG. 16, step S1210 in FIG. 15 is explained in detail. In FIG. 16, step S1210 is conceptually expressed in a form of a flow chart as the image-pick-up processing program 404b.

The image-pick-up processing program 404b starts with step S2001 to make a zero initialization of a pattern number PN indicative of one of successive mask patterns which is to be used for forming a corresponding one of the successive patterned lights. Subsequently, in step S2002, it is determined whether or not a current value of the pattern number PN is smaller than a maximum value PNmax. The maximum value PNmax is pre-determined so as to reflect the total number of the mask patterns to be used. For example, when eight patterned lights are to be used in total, the maximum value PNmax is set to eight.

If the current value of the pattern number PN is smaller than the maximum value PNmax, then the determination in step S2002 becomes “YES,” and the processing advances to step S2002a to execute the mask motor control program 404k.

As shown in FIG. 17, the mask motor control program 404k starts with step S2201 to supply a signal to the mask motor driver 86 for driving the mask motor 65 for rotation at a constant speed. As a result, the mask 200 is fed in a direction allowing the mask 200 to advance from the supply roller 220 toward the illuminated position 228.

Subsequently, in step S2202, the signal PD is read out from the position sensor 300. Thereafter, in step S2203, it is determined whether or not the read signal PD is low in level. That is, it is determined whether or not the position sensor 300 has detected any one of the position reference holes 280 (in this instance, a leading one of the position reference holes 280).

If the current signal PD is high in level, then the determination in step S2203 becomes “NO,” and the processing returns to step S2201 to repeat operations for driving the mask motor 65 and reading the signal PD. If the signal PD changes from high to low level as a result of the some repetitive implementations of steps S2201 to S2203, then the determination in step S2203 becomes “YES”.

Thereafter, in step S2204, the signals S1 through S3 are read from the first through third ID sensors 310, 312 and 314, respectively. Subsequently, in step S2205, it is determined whether or not the combination of the levels of the read signals S, S2 and S3 (information indicated by three-bit data) is indicative of the current value of the pattern number PN. In other words, it is determined whether or not one of the frames 202 in the mask 200 which is currently located at the illuminated position 228, that is, the current frame 202 has been assigned a pattern number PN equal to the current value of pattern number PN.

If the pattern number PN of the current frame 202 does not coincide with the current value of the pattern number PN, then the determination in step S2205 becomes “NO”, eventually returning to step S2201. On the other hand, if the pattern number PN of the current frame 202 coincides with the current value of the pattern number PN, then the determination in step S2205 becomes “YES”. In this embodiment, the pattern number PN is incremented one in the same order as that in which the a plurality of frames 202 is arrayed in the mask 200. That is, the mask 200 is fed sequentially, and therefore, the determination in step S2205 becomes “YES”, unless the three-dimensional shape detection device 10 malfunctions.

If the determination in step S2205 becomes “YES”, then, the processing advances to step S2206 to deactivate the mask motor 65, whereby the current frame 202 is stopped at the illuminated position 228. As a result, the locating of the current frame 202 is completed.

Due to the above-mentioned steps, the execution of the mask motor control program 404k is finished one time.

It is added that, in this embodiment, the mask motor 65 is controlled so as to allow the plurality of frames 202 to be sequentially located at the illuminated position 228 due to the intermittent feeding of the mask 200 which is achieved by the intermittent drive of the mask motor 65. On the other hand, the present invention may be alternatively practiced such that the mask motor 65 is controlled so as to allow the plurality of frames 202 to be sequentially located at the illuminated position 228 due to the continuous feed of the mask 200 which is achieved by the continuous drive of the mask motor 65.

As described above, in this embodiment, each through hole 204 is oriented to have a longitudinal direction parallel to the feed direction of the mask 200. Accordingly, this embodiment makes it easier to secure an adequate length of time, even when the mask 200 is in motion for which same patterned light is continuously generated using an arbitrary one of the frames 202 and is continuously projected onto the object S to be picked up, during passage of the same frame 202 through the illuminated position 228.

Therefore, despite that the mask 200 is fed with no temporary stop, this embodiment makes it easier to project the same patterned light onto the object S to be picked up to form an apparent still picture. This is advantageous for allowing the plurality of frames 202 to be sequentially located precisely at the illuminated position 228 as a result of the continuous feed of the mask 200.

In this embodiment, upon completion of the execution of the mask motor control program 404k one time, the processing advances to step S2003 in FIG. 16 to initiate the projection of a PN-th mask pattern which is one of the mask patterns to be used, which has been assigned a pattern number equal to the current value of the pattern number “PN”.

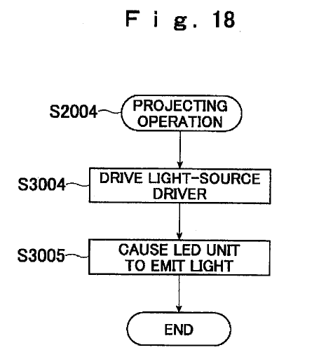

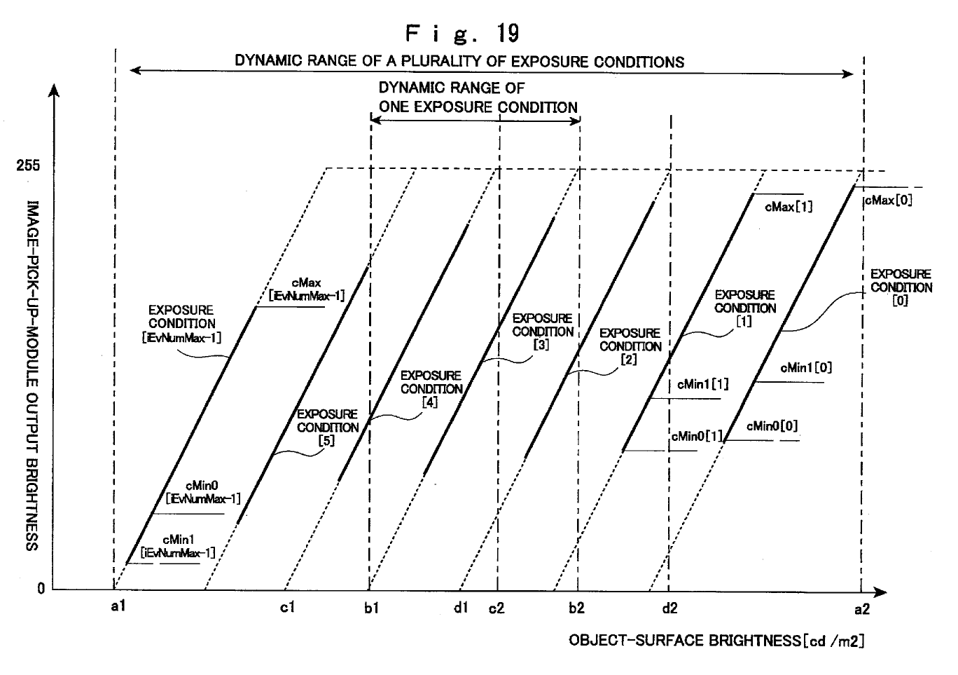

Subsequently, in step S2004, the projecting operation is performed for projecting the PN-th mask pattern onto the object S to be picked up. In FIG. 18, the detail of step S2004 is conceptually expressed in a form of a flow chart as a projecting operation subroutine. As a result of the execution of this projecting operation subroutine, the projecting operation is performed to project the patterned light of the PN-th mask pattern, emitted from the projection part 12 onto the object S to be picked up, in cooperation with the projection mechanism 66.

The projecting operation starts with step S3004 to drive the light-source driver 84, and step S3005 follows to cause the LED unit 62 to emit light in response to an electrical signal from the light-source driver 84. Then, this projecting operation is finished.

Light emitted from the LED unit 62 reaches the projection mechanism 66 through the light-source lens 64. In the projection mechanism 66, the spatial modulation is applied in conformity with the aperture pattern of the current frame 202 of the mask 200, thereby converting light (original light) coming into the projection mechanism 66 into the patterned light. The patterned light is outputted from the projection mechanism 66 and then reaches the object S to be picked up by way of the projection optical system 32, to form a projection image on the object S to be picked up by light projection.

Once the PN-th patterned light which is formed by the PN-th mask pattern is projected onto the object S to be picked up in the manner described above, and then, in step S2005 in FIG. 16, the image pick-up part 14 is activated to pick up the object S to be picked up with the PN-th patterned light being projected onto the object S to be picked up.

This pick-up processing results in the pick-up of a PN-th patterned-light illuminated image which represents the object S to be picked up onto which the PN-th patterned light has been projected. The picked-up patterned-light illuminated image is stored in the patterned-light illuminated image storing part 406a in association with the corresponding pattern number PN.

Here, the exposure conditions in the image pick-up part 14 will be explained in more detail by reference to FIG. 19. A graph shown in FIG. 19 shows the relationships between the output brightnesses of image signals outputted from the image pick-up part 14 and the actual brightnesses on a surface of the object S to be picked up, wherein these relationships express the characteristics of the respective exposure conditions in the image pick-up part 14. Here, the graph shown in FIG. 19 is schematically expressed by taking a logarithmic scale on an axis of abscissas (surface brightness of object to be picked up).

In this embodiment, as the exposure conditions of the image pick-up part 14, seven exposure conditions consisting of the exposure condition [0] to the exposure condition [iEvNumMax−1] are provided. The exposure condition [0] provides the lowest exposure (minimum exposure), and the degree of exposure is increased in order of the exposure condition [1], the exposure condition [2], . . . , and the exposure condition [iEvNumMax−1]. The exposure condition [iEvNumMax−1] provides the highest exposure (maximum exposure). Although a dynamic range of one exposure condition is narrow as shown in FIG. 19, the surface brightness of the object S to be picked up which the image pick-up part 14 can pick up can acquire a wide range by changing over these seven exposure conditions.

Further, the surface brightnesses of the object S to be picked up which can be detected under the respective exposure conditions have dynamic ranges of the neighboring exposure conditions overlapping with each other. For example, the dynamic range (range from b1 to b2 in FIG. 19) of the exposure condition [3] overlaps with the dynamic range (range from c1 to c2 in FIG. 19) of the exposure condition [4] and the dynamic range (range from d1 to d2 in FIG. 19) of the exposure condition [2]. Accordingly, the surface brightness (a1 to a2 in FIG. 19) within a predetermined range of the object S to be picked up falls within the dynamic range of any one of the exposure conditions between the lowest exposure and the highest exposure. Here, with respect to the respective image pick-up conditions, ranges (cMin0[iEvNum] to cMax[iEvNum]) narrower than the respective dynamic ranges of the exposure conditions are set as effective brightness ranges for selecting the code edge coordinates described later.

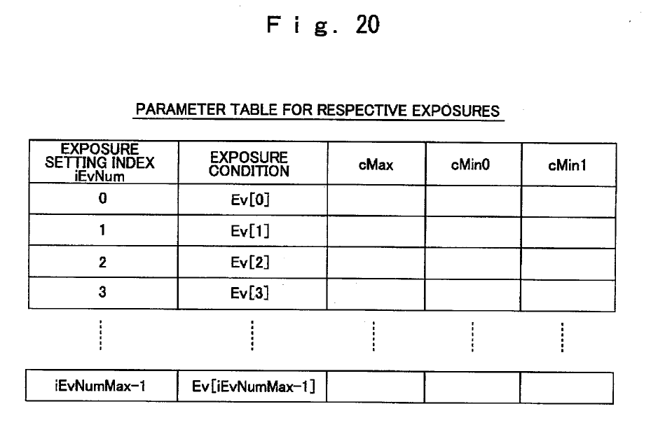

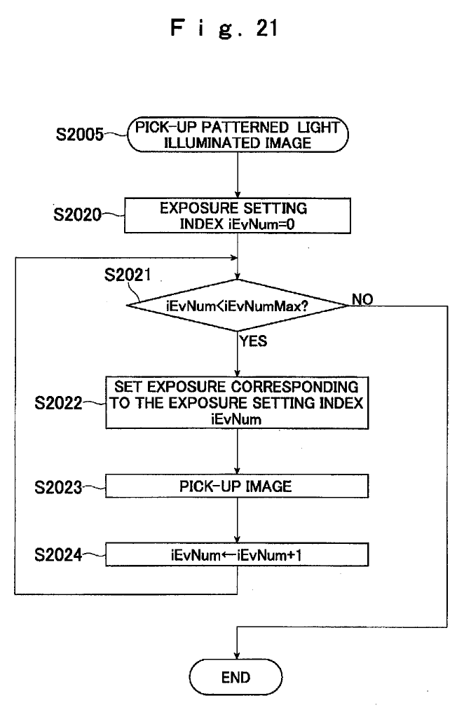

Here, setting of the exposure conditions of the image pick-up part 14 is performed by setting one exposure time parameter out of the plurality of exposure time parameters stored in the parameter table storing part 406w for respective exposures to the image pick-up part 14. That is, the CPU 402 takes out the exposure time parameter from the parameter table storing part 406w for respective exposures, transmits the exposure time parameter to the image pick-up part 14, and picks up an image within the exposure time corresponding to the exposure time parameter on the image pick-up part 14 side. Here, as shown in FIG. 20, in the parameter table storing part 406w for respective exposures, the exposure setting indexes iEvNum are stored respectively corresponding to the exposure conditions. That is, the exposure time parameters Ev[0] to Ev[iEvNumMax−1] respectively correspond to the exposure conditions [0] to the exposure condition [iEvNumMax−1].

Here, in this embodiment, the exposure time of the image pick-up part 14 can be changed under seven exposure conditions consisting of the exposure condition [0] to the exposure condition [iEvNumMax−1]. However, when the image pick-up part 14 having the large dynamic ranges is used, it is unnecessary to provide seven exposure conditions.

Here, by reference to FIG. 21, the processing in step S2005 depicted in FIG. 16 will be described in more detail. In FIG. 21, step S2005 is conceptually expressed in a form of a flowchart as a patterned-light image pick-up processing subroutine. This subroutine is processing for executing the image pick-up processing 404b using the CPU 402.

In this subroutine, first of all, in step S2020, the exposure setting index iEvNum is reset to “0”.

Next, in step S2021, it is determined whether or not the exposure setting index iEvNum is smaller than “iEvNumMax”. Since the exposure setting index iEvNum is “0” which is smaller than “iEvNumMax” this time, the determination in step S2021 becomes “YES”, and in step S2022, the exposure condition [iEvNum] corresponding to the exposure setting index iEvNum is set in the image pick-up part 14.

For example, when the exposure setting index iEvNum is “0”, out of the exposure time parameters Ev[0] to the Ev[iEvNumMax−1] corresponding to the plurality of exposure conditions, the exposure time parameter Ev[0] is taken out from the parameter table storing part 406w for respective exposures. The exposure time parameter Ev[0] taken out in this manner is set in the image pick-up part 14. When the exposure time parameter Ev[0] is set in the image pick-up part 14, the image pick-up part 14 can pick up an image under the exposure condition [0].

Next, in step S2023, an image of the object S to be picked up to which the N-th patterned light is projected is picked up by the image pick-up part 14 within the exposure time corresponding to the exposure time parameter. The patterned-light illuminated image picked up in this manner is stored in the patterned light illuminated image storing part 406a.

Upon completion of the image pick-up operation by the image pick-up part 14, in step S2024, the exposure setting index iEvNum is incremented by 1. Subsequently, the processing returns to step S2021, and it is determined whether or not the exposure setting index iEvNum is smaller than “iEvNumMax”. If the exposure setting index iEvNum is smaller than the “iEvNumMax” this time, the determination in step S2021 becomes “YES” and the processing advances to step S2022.

As the result of the repetition of the execution of image pick-up processing in step S2023 which is performed the number of times equal to the numerical value of the exposure setting index iEvNumMax, when the exposure setting index iEvNum becomes equal to or more than “iEvNumMax”, the determination in step S2021 becomes “NO”, and the patterned-light image pick-up processing based on the image pick-up processing program 404b is finished.

Upon completion of this pick-up processing, in step S2006, the projection of the PN-th patterned light is finished, and then, in step S2007, the pattern number PN is incremented by 1 in preparation for the projection of the next patterned light. Then, the processing returns to step S2002.

When the current value of the pattern number PN, as a result of the repetition of execution of steps S2002 to S2007 a number of times equal to the number of kinds of the patterned light, assumes a value not smaller than the maximum value PNmax, the determination in step S2002 becomes “NO,” and this image pick-up processing is finished. As will be evident from the above, one cycle of implementation of the image-pick-up processing allows the acquisition of patterned-light illuminated images whose number is equal to the maximum value PNmax for respective exposure conditions.

Subsequently, in step S2008, it is determined whether or not a flash mode is selected. If so, then the determination in step S2008 becomes “YES,” and the processing advances to step S2009 to activate the flash light 26 to emit light, and otherwise the determination in step S2008 becomes “NO,” and step S2009 is skipped. In any event, step S2010 follows to pick up the image of the object S to be picked up.

The image pick-up is performed for the purpose of measuring the surface color of the object S to be picked up without projecting any patterned light coming from the projection part 12 onto the object S to be picked up. As a result, a single patterned-light-non-illuminated image is acquired for the object S to be picked up. The acquired patterned-light-non-illuminated image is stored in the patterned-light-non-illuminated image storing part 406b. Here, as the exposure condition in the image pick-up part 14, the exposure condition acquired by the automatic exposure function in step S1004 is used. However, the intermediate exposure condition out of the plurality of exposure conditions may be used.

Thereafter, in step S2011, the mask motor 65 is driven for initializing the position of the mask 200 in the lengthwise direction so as to allow a leading portion of the mask 200 in the lengthwise direction to be located at the illuminated position 228.

Due to the above-mentioned steps, the execution of the image-pick-up processing program 404b is finished one time.

In this embodiment, the CCD 70 undergoes exposure to the incoming light from the object S to be picked up, and then a signal that reflects the exposure is read out from the CCD 70. One signal-readout cycle corresponds to one exposure cycle, and the exposure cycle and the signal-readout cycle cooperate to constitute one of image-pick-up sub-processes.

In this embodiment, the acquisition of the three-dimensional shape information and the surface-color information is consecutively performed for the same object S to be picked up in the description order.

To acquire the three-dimensional shape information of the object S to be picked up, first of all, the exposure time parameter under the lowest exposure condition [0] out of the plurality of exposure conditions [0] to [iEvNumMax−1] is taken out from the parameter table storing part 406w for respective exposures, and the exposure time parameters under other exposure conditions are sequentially taken out, and the image pick-up operation is performed under the respective exposure conditions. The image pick-up processing under such plurality of exposure conditions is performed for respective eight kinds of patterned lights (pattern number PN=0 to 7) projected sequentially to the object S to be picked up. That is, to acquire the three-dimensional shape information of the object S to be picked up, the individual image pick-up processing with respect to the object S to be picked up is sequentially performed eight times for every exposure condition, that is, the individual image pick-up processing is performed 8×EvNumMax times in total.

Here, by referring to FIG. 22, step S1220 depicted in FIG. 15 is described in greater detail. FIG. 22, step S1220 is conceptually expressed in a form of a flow chart as a 3-D measurement processing subroutine.

This 3-D measurement processing subroutine starts with step S4001 to reset the exposure setting index iEvNum to “0” by the execution of the camera control program 404a using the CPU 402.

Next, in step S4002, it is determined whether or not the exposure setting index iEvNum is smaller than “iEvNumMax”. Since the exposure setting index iEvNum is “0” which is smaller than “iEvNumMax” this time, the determination in step S4002 becomes “YES”, and in step S4003, by executing the brightness image generation program 404c, based on the plurality of patterned-light illuminated image picked up under the exposure condition [iEvNum] corresponding to the exposure setting index iEvNum, the brightness image under the exposure condition [iEvNum] corresponding to the exposure setting index iEvNum is generated.

In step S4003, the brightness value is defined as a Y value in an YCbCr space, and the Y value is calculated using a following formula based on RGB values of each pixel.

Y=0.2989·R+0.5866·G+0.1145·B

By acquiring the Y value with respect to each pixel, the plurality of brightness images respectively corresponding to the plurality of patterned-light illuminated images under the exposure condition [iEvNum] corresponding to the exposure setting index iEvNum is generated. There generated brightness images are stored in the brightness image storing part 406c associated with the exposure setting index iEvNum and the pattern number PN. However, a formula used for calculating the brightness value is not limited to the above-mentioned formula and other formula may be used with proper modification.

Next, in step S4004, the CPU 402 executes the maximum brightness image generation program 404f. When this maximum brightness image generation program 404f is executed, the maximum brightness image is generated from the plurality of brightness images under the exposure condition [iEvNum] corresponding to the exposure setting index iEvNum stored in the brightness image storing part 406c. The generated maximum brightness image is stored in the maximum brightness image storing part 406v associated with the exposure setting index iEvNum.

The generation of the maximum brightness image is performed by collecting the maximum brightness values of the plurality of brightness images for each pixel under the exposure condition corresponding to the exposure setting index iEvNum. That is, the maximum brightness image is generated by extracting the highest brightness value out of the plurality of brightness images under the exposure condition [iEvNum] corresponding to the exposure setting index iEvNum for every coordinates position of a CCD coordinates system ccdx-ccdy which is a two-dimensional coordinates system set on an imaging face of the CCD 70.

Next, in step S4005, the CPU 402 executes a coded-image generation program 404d. When the coded-image generation program 404d is executed, a coded image to which a space code is allocated for each pixel is generated due to the combination of the plurality of brightness images under the exposure condition [iEvNum] corresponding to the exposure setting index iEvNum. The coded image is generated using a resultant image (binarized image) of binarization processing (threshold processing) which compares the brightness images on the plural kinds of patterned-light illuminated images under the exposure condition [iEvNum] corresponding to the exposure setting index iEvNum stored in the brightness image storing part 406c and a threshold image to which a brightness threshold value is allocated for every pixel. The generated coded image is stored in a coded image storing part 406d associated with the exposure setting index iEvNum.

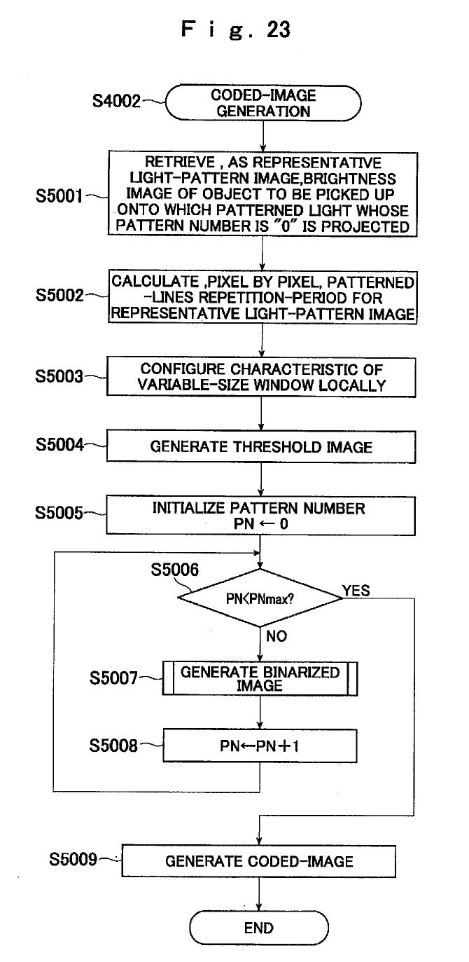

In FIG. 23, the detail of this coded-image generation program 404d is conceptually expressed in a form of a flow chart. The technique employed in the coded-image generation program 404d, particularly the technique for generating a threshold image in step S5001 to step S5004, is disclosed in more detail in Japanese Patent Application 2004-285736 that was filed by the same applicant as that of the present application, the disclosure of which is herein incorporated by reference in its entirety.

The coded-image generation program 404d will be described time sequentially below, the underlying principle of which will be described beforehand.

In this embodiment, a plurality of brightness images is generated for the same object S to be picked up (three-dimensional object to be picked up) under the effect of plural kinds of projected patterned light, respectively. The different patterned lights are each structured so as to have bright portions, that is, bright patterned lines each having a width, and dark portions, that is, dark patterned lines each having a width, which alternate in a uniform patterned-lines repetition-period or at equal intervals. The different patterned lights, each of which is referred to as a patterned light having a pattern number PN, are different from each other in terms of a repetition period of the patterned lines in each patterned light. One of the patterned lights which has the shortest patterned-lines repetition-period among them is a patterned light having a pattern number PN of “0,” while one of the patterned lights which has the longest patterned-lines repetition-period among them is a patterned light having a pattern number PN of “PNmax−1.”

Each and every brightness image, because of its acquisition with the projection of a corresponding patterned light, is formed as a light-pattern image in which bright patterned lines as bright portions and dark patterned lines as dark portions alternate in a linear array. The distances or spacings between adjacent patterned lines, because of their dependency upon the relative geometry (the relations on position and orientation) between the three-dimensional shape detection device 10 and the object S to be picked up, are not always uniform throughout each brightness image. In addition, the plurality of brightness images respectively acquired with the effect of the plural kinds of the projected patterned light is identified by the pattern numbers PN of the corresponding respective patterned light.

In this embodiment, one of the plurality of brightness images is selected as a representative light-pattern image. The typical example of such a representative light-pattern image is a brightness image corresponding to one of the plurality of patterned lights which has the shortest patterned-lines repetition-period among them, that is, a brightness image having a pattern number PN of “0”.

In the brightness image acquired by picking up an image of the object S to be picked up onto which a patterned light has been projected, a brightness value changes spatially and periodically in the pixel array direction. There exists an envelope curve tangent to a graph indicating the periodical change of the brightness value, at plural lower peak points (minimum brightness points) of the graph. For a pixel-by-pixel brightness-value of a brightness image featured by such an envelope curve to be accurately binarized through threshold processing, a threshold value used therein is preferably caused to vary corresponding to a pixel position. That is, the threshold value is preferably caused to adaptively vary to follow an actual change in the brightness value in a brightness image through tracking.

Based on the above findings, in this embodiment, a filtering-window for calculating a threshold value by applying filter processing to an brightness image is locally set, and the threshold value suitable for the position of the brightness image is locally set with respect to the brightness image. Once a window is set at one local position of the brightness-image, a brightness value of the pixel which exists in the window out of the plurality of patterns which constitute the brightness image is extracted and referenced for setting a threshold value corresponding to the local position.

The window used in this embodiment is in the form of a rectangular window. When using this rectangular window, the plurality of patterned lines are selected which are found through the rectangular window, pixels are selected which are present within the rectangular window, and the brightness values of the selected pixels are extracted from the target brightness-image. Common weighting-factor(s) is applied to the extracted brightness values for threshold calculation. The weighting factor(s) defines a window function of the rectangular window.

Additionally, when using this rectangular window, corresponding to a line-direction-size measured in a line direction in which each of arrayed patterned-lines of a target brightness-image elongates, the number of pixels present within the rectangular window in the line direction can be varied. While corresponding to an array-direction-size measured in an array direction in which the plurality of patterned lines is arrayed, the number of pixels present within the rectangular window in the array direction can be varied.

As a result, when using the rectangular window, a local threshold value calculated from a target brightness-image by locally applying the rectangular window thereto can vary as a function of the array-direction-size of the rectangular window. Therefore, adaptive change in the value of local threshold, if required, can be adequately achieved by adaptive change in the array-direction-size of rectangular window.

In this embodiment, the size of the window formed as a rectangular window is preferably set such that the number of the patterned lines is equal to any one of the integer multiples of the spacing or period of the patterned lines (for example, the period in which bright patterned lines repeat) within the window. In other words, the window size is preferably set to allow bright patterned lines and dark patterned lines to be present in the window in equal numbers. The thus-setting of the window-size, as a result of the calculation of the average of brightness values of the plurality of patterned lines within the window, allows the accurate determination of proper threshold values.

A possibility, however, exists that the repetition period of patterned lines can vary with location, even on the same brightness image. For this reason, a fixed-size window can cause the number of patterned lines within the window, to vary with location, resulting in degraded thresholds in accuracy.

In this embodiment, among the plurality of patterned lights, one brightness image is selected as a representative light-pattern image, which was acquired with the effect of projection of a patterned light which has the shortest patterned-lines repetition-period, that is, a brightness image having a pattern number PN of “0.” Further, in this embodiment, a window which is locally applied to the representative light-pattern image, is in the form of the variable-size window VW. Owing to this, the variable-size window VW is caused to adaptively change in size in response to the repetition period of actual patterned lines in the representative light-pattern image.

Accordingly, in this embodiment, even when the repetition period of patterned lines in the representative light-pattern image changes corresponding to the position in the array direction of the representative light-pattern image, the size of the variable-size window VW changes so as to follow the change in the repetition period, with the result that the total number of bright and dark patterned-lines within the variable-size window VW remains constant, irrespective of changes in the repetition period of patterned lines. In this embodiment, a threshold value TH is determined each time the variable-size window VW is locally applied to the representative light-pattern image on a local-position-by-local-position basis. The local-position-by-local-position threshold value TH is accurately obtained based on the variable-size window VW optimized in size on a local-position-by-local-position basis.

In addition, the variable-size window VW, which allows the total number of bright and dark patterned-lines within the variable-size window VW to remain constant, is minimized in size when those patterned-lines appear on a brightness image having a pattern number PN of “0.” For this reason, the selection of the brightness image having a pattern number PN of “0” as the representative light-pattern image allows the variable-size window VW to be minimized in size, and eventually allows suppression in computational load for filtering after using the variable-size window VW.

In this embodiment, the variable-size window VW is in the form of a rectangular-window having a variable size. This variable-size window VW is configured so as to be variable in size in the array direction of the representative light-pattern image, and so as to be fixed in the line direction of the representative light-pattern image.

In this embodiment, the size of the variable-size window VW, that is, the size of the variable-size window VW measured in the array direction of the representative light-pattern image, is set so as to adaptively reflect the spacings between the actual patterned lines of the representative light-pattern image. This adaptive setting of the size of the variable-size window VW requires prior knowledge of the distribution of the actual patterned-line spacings of the representative light-pattern image.

For these reasons, in the present embodiment, prior to the adaptive setting of the size of the variable-size window VW, a fixed-size window is locally applied to the representative light-pattern image. A plurality of adjacent pixels picked up at a time by application of the fixed-size window are selected as a plurality of target pixels, and based on the brightness values of the selected target pixels, the distribution of the actual patterned-line spacings of the representative light-pattern image is determined.

In the present embodiment, additionally, Fast Fourier Transform (FFT) is performed on the brightness values of a plurality of target pixels in the representative light-pattern image, thereby measuring intensities (for example, power spectrum) of frequency components of a series of brightness values found in the representative light-pattern image, resulting from variations in the brightness value in the array direction of the representative light-pattern image. In this regard, “frequency components” means the number of repetition in which uniform brightness values repeat in an array direction of the plurality of target-pixels picked up by the fixed-size window, wherein the target pixels are sequenced in the array direction of the representative light-pattern image.

In the present embodiment, each one of the plurality of adjacent pixels which is successively and laterally arrayed in the representative light-pattern image is sequentially selected as a target pixel and, based on a brightness value distribution of the representative light-pattern image, the distribution of the patterned-line spacings is acquired per each of the thus-selected target pixels. By referring the acquired patterned-line spacing, a determination is made as to a size of the variable-size window VW used in filtering processing for generating the threshold image.

This coded-image generation program 404d, although has been explained above in terms of its basic idea, will be explained below time sequentially by referring to FIG. 23.

This coded-image generation program 404d starts with step S5001 to retrieve, from the brightness image storing part 406c, the brightness image of the object S to be picked up which was picked up with the patterned light whose pattern number PN is “0” being projected onto the object S to be picked up, as the representative light-pattern image.

Next, in step S5002, a pixel-by-pixel calculation is made of a patterned-lines repetition-period in association with each of adjacent pixels consecutively sequenced within the representative light-pattern image in the array direction thereof, based on the retrieved brightness image, by an approach of the aforementioned FFT conversion. A plurality of calculated patterned-lines-repetition-periods is stored in the period distribution storing part 406p, in association with the respective pixels (respective pixel-positions in the array direction).

Subsequently, in step S5003, the characteristic of the variable-size window VW is locally configured in succession based on the plurality of calculated patterned-lines-repetition-periods. In the present embodiment, the variable-size window VW is configured such that its line-direction-size is kept unchanged irrespective of the position on the representative light-pattern image to which the variable-size window VW is locally applied, while the array-direction-size is variable to be kept equal to an integer multiple of the patterned-lines repetition-periods calculated in association with the respective positions arrayed in the array direction of the representative light-pattern image.

Thereafter, in step S5004, the variable-size window VW is locally applied to the representative light-pattern image in a two-dimensional sliding manner (sliding in both the line direction and the array direction) in association with respective pixels. Due to the setting of the variable-size window VW, a pixel-by-pixel calculation is made with respect to the brightness-value average of the plurality of pixels present within the variable-size window VW as a local threshold. In step S5004, by its further implementation, a threshold image is generated by allocating the thus-calculated local thresholds to the corresponding respective pixels of the representative light-pattern image. The generated threshold image is stored in the threshold image storing part 406q associated with the exposure setting index iEvNum.

Subsequently, in step S5005, the pattern number PN is initialized to “0,” and then, in step S5006, it is determined whether or not a current value of the pattern number PN is smaller than the maximum value PNmax. In this instance, the current value of the pattern number PN is “0”, and therefore, the determination in step S5006 becomes “No” and the processing advances to step S5007.

In step S5007, a pixel-by-pixel comparison is made between the brightness values of the brightness image whose assigned pattern number PN is equal to the current value of the pattern number PN and the exposure condition [iEvNum] corresponds to the exposure setting index iEvNum, and the local threshold values of the generated threshold image under the exposure condition [iEvNum] corresponding to the generated exposure setting index iEvNum. A binarized image is formed pixel-by-pixel so as to reflect the result of the pixel-by-pixel comparison. More specifically, when the brightness image has its brightness value greater than the corresponding local threshold value, data indicative of a binary “1” is stored in the binarized image storing part 406r in association with the corresponding pixel position of the corresponding binarized image. On the other hand, when the current brightness image has its brightness value not greater than the corresponding local threshold value, data indicative of a binary “0” is stored in the binarized image storing part 406r in association with the corresponding pixel position of the corresponding binarized image.

Thereafter, in step S5008, the pattern number PN is incremented by 1 and then the processing returns to step S5006 to make a determination as to whether or not a current value of the pattern number PN is smaller than the maximum value PNmax. If so, then the determination in step S5006 becomes “NO,” and the processing advances to step S5007.

If the current value of pattern number PN, as a result of the repetition of the execution of steps S5006 to step S5008 a number of times equal to the number of kinds of the patterned lights, becomes not smaller than the maximum value PNmax, the determination in step S5006 becomes “YES,” and the processing advances to step S5009.

In step S5009, pixel-by-pixel pixel extraction is performed of pixel values (either a binary “1” or “0”) from a set of binarized images whose the exposure condition [iEvNum] corresponds to the exposure setting index iEvNum and the number is equal to the maximum value PNmax, in the sequence from a binarized image corresponding to a brightness image whose pattern number PN is “0” to a binarized image corresponding to a brightness image whose pattern number PN is “PNmax−1,” resulting in the generation of a space code made up of bits arrayed from a least significant bit LSM to a most significant bit MSB. The number of bits collectively making up a pixel-by-pixel space-code is equal to the maximum value PNmax. The pixel-by-pixel generation of space codes results in the generation of a space coded image corresponding to the object S to be picked up of this time. The generated space codes are stored in the space coded-image storing part 116d, in association with the corresponding respective pixel positions and the exposure setting index iEvNum. In an example where the maximum value PNmax is equal to eight, the resulting space codes have values ranging from 0 to 255.

Due to the above-mentioned steps, the execution of the coded-image generation program 404d is finished one time.

Thereafter, in step S4006 depicted in FIG. 22, code-edge-coordinates detection processing is performed by the execution of the code edge extraction program 404e. In the present embodiment, encoding is carried out using the aforementioned space-encoding technique on a per-pixel basis, resulting in the occurrence of a difference on a sub-pixel accuracy between an edge line separating adjacent bright and dark portions in an actual patterned light, and an edge line of the space-codes (edge line between a region to which one space code is allocated and a region to which another space code is allocated) in the generated coded-image under the exposure condition [iEvNum] corresponding to the exposure setting index iEvNum. In view of the above, the code-edge-coordinates detection processing is performed for the purpose of detecting code edge coordinate values of space codes with sub-pixel accuracy. The detail of the processing for detecting the edge coordinate value of the space code with sub pixel accuracy is disclosed in detail in Japanese patent application 2004-1054261 filed by inventors of the present application.

In this code edge coordinates detection processing, a change of brightness is approximated using a polynomial by reference to the brightness image in the vicinity of the edge coordinate value (with accuracy of integer since the detection can be performed only at an edge of the pixel) detected by reference to the code image and, at the same time, an average value of threshold values in the vicinity of the edge coordinate value is calculated. Then, by calculating a crossing point of the polynomial which approximates the change of brightness and the average value of the threshold values in the vicinity of the edge coordinate value (decimal accuracy: sub pixel accuracy), the edge coordinate value of the space code is detected with sub pixel accuracy.

In an example, provided that positions of 255 lines of discrete reference lines each of which intersects with the line direction of each patterned light are defined in a CCD coordinate system, if the maximum value PNmax is equal to eight (256 space codes, therefore 255 edge lines exist), about 65,000 edge coordinate values of the space code are detected at the maximum, as a result of the implementation of step S4003 (the implementation of the code edge extraction program 404e) depicted in FIG. 22. That is, the code edge number 255 of the space code is defined by the first edge position index Icode, and the first edge position index Icode=0 to 254 is allocated. Further, the pixel unit which constitutes each code edge for every first edge position index Icode=0 to 254 is defined as the second edge position index Iccdx, and the second edge position index Iccdx=0 to 254 is allocated. Accordingly, the number of code edge coordinates in the space code is a value acquired by multiplying the number of first edge position index with the number of second edge position index, that is, approximately 65,000.

The detected code edge coordinate values are stored in the code edge coordinates storing part 406e. The code edge coordinate values are defined in a CCD coordinate system ccdx-ccdy which is a two-dimensional coordinate system fixed with respect to the image plane of the CCD 70.

Thereafter, in step S4007, the exposure setting index iEvNum is incremented by 1. Subsequently, the processing returns to step S4002, and it is determined whether or not the exposure setting index iEvNum is smaller than “iEvNumMax”. This time, if the exposure setting index iEvNum is “iEvNumMax” or more, the determination in step S4002 becomes “YES” and the processing advances to step S4003.

When the exposure setting index iEvNum assumes a value equal to or more than iEvNumMax as a result of repetition of the execution of step S4003 or step S4006 a number of times equal to the number of exposure setting index iEvNum, the determination in step S4002 becomes “NO” and the processing advances to step S4008.

Due to the above-mentioned steps, the execution of the code edge extraction program 404e is finished one time.

Thereafter, in step S4008 shown in FIG. 24, the CPU 402 executes the integration program 404g of code edges so as to execute the integration processing of code edge positions.

Here, by reference to FIG. 24, step S4008 shown in FIG. 22 is explained in detail. In FIG. 24, step S4008 is conceptually expressed in a form of a flow chart as an integration subroutine of the code edges.

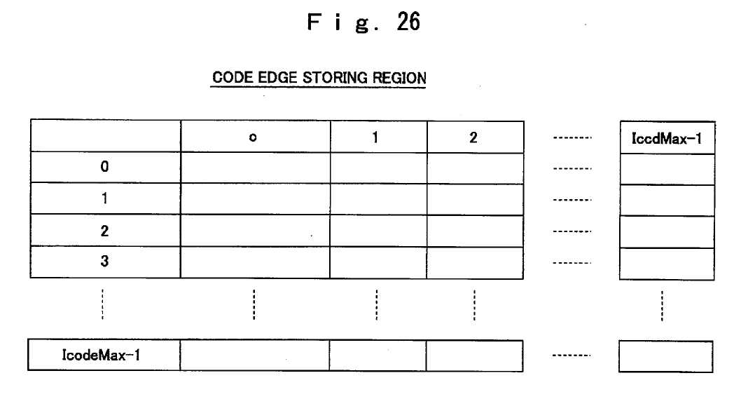

First of all, in step S5100, a region which preserves code edge coordinates integrated by integration processing of the code edges (hereinafter referred to as “integration code edge coordinates”) (hereinafter referred to as “integration code edge coordinates storing region”) is ensured in a code edge coordinates storing part 406e. This integration code edge coordinates storing region is configured, as shown in FIG. 26, such that the respective code edge positions (Icode, Iccdx) can be stored in the integration code edge coordinates storing region for the respective code edge positions.

Next, in step S5101, the first edge position index Icode is initialized by being set to “0”. Subsequently, in step S5102, it is determined whether or not the first edge position index Icode is smaller than “IcodeMax”. Since the first edge position index Icode is “0” which is smaller than “IcodeMax” this time, the determination in step S5102 becomes “YES”. Accordingly, in step S5103, the second edge position index Iccdx is initialized by being set to “0”. That is, the second edge position index Iccdx is set to “0”. The first edge position index Icode and the second edge position index Iccdx set in such a manner are stored in a working area 410. When the first edge position index Icode and the second edge position index Iccdx are incremented in step S5107 and S5108 described later, the first edge position index Icode and the second edge position index Iccdx stored in the working area 410 are updated each time that such increment is effected.

Thereafter, in step S5104, it is determined whether or not the second edge position index Iccdx assumes a value smaller than “IccdxMax”. Since the second edge position index Iccdx is “0” which is smaller than “IccdxMax”, the determination in step S5104 becomes “YES”. Accordingly, in step S5105, the selection processing of the code edges explained in detail later is performed. The code edge coordinates selected by the selection processing of code edges are stored in the above-mentioned integration code edge coordinates storing region in step S5106.

Thereafter, in step S5107, the second edge position index Iccdx is incremented by only 1. Subsequently, the processing returns to step S5104 and it is determined whether or not the second edge position index Iccdx assumes a value smaller than “IccdxMax”. If the second edge position index Iccdx is not a value smaller than “IccdxMax” this time, the determination in step S5104 becomes “NO” and the processing advances to step S5108.

When the processing advances to step S5108, in step S5108, the first edge position index Icode is incremented by only 1. Subsequently, the processing returns to step S5102 and it is determined whether or not the first edge position index Icode assumes a value smaller than “IcodeMax”. If the first edge position index Icode is not a value smaller than “IccdxMax”, the determination in step S5102 becomes “NO” and the integration processing of code edges is finished.

Here, step S5105 in FIG. 24 is explained in detail by reference to FIG. 25. In FIG. 25, step S5105 is conceptually expressed in a form of a flow chart as a selection program 404h of the code edges.

First of all, in step S5200, the value of exposure setting index iEvNum is initialized. That is, the exposure setting index iEvNum is set to “0”. The exposure setting index iEvNum−1 processed immediately before the exposure setting index iEvNum during processing in this flow chart is assumed as the previous-time exposure setting index iEvNumB, and this previous-time exposure setting index iEvNumB is set to “−1”.

Next, in step S5201, it is determined whether or not the exposure setting index iEvNum assumes a value smaller than “iEvNumMax”. Since the exposure setting index iEvNum is “0” smaller than “iEvNumMax”, the determination in step S5201 becomes “YES”, and in step S5202, the code edge coordinates (ccdx, ccdy) of the image-pick-up condition corresponding to the exposure setting index iEvNum is acquired. The code edge coordinates acquired here are code edge coordinates determined based on the first edge position index Icode and the second edge position index Iccdx stored in the working area 410.

Subsequently, in step S5203, it is determined whether or not the acquired code edge coordinates (ccdx, ccdy) are indeterminate. Here, the condition that the code edge coordinates (ccdx, ccdy) are indeterminate implies that the code edge coordinates cannot be detected in code edge extracting processing in step S4006.

When it is determined that the acquired code edge coordinates (ccdx, ccdy) are indeterminate in step S5203, the determination in step S5203 becomes “NO”, and in step S5204, an average brightness value (AveY) in the vicinity of the acquired code edge coordinates (ccdx, ccdy) is acquired. Here, the average brightness value (AveY) in the vicinity of the code edge coordinates (ccdx, ccdy) is calculated in this step S5204 based on the maximum brightness image formed in step S4004. For example, the brightness values respectively corresponding to the code edge coordinates (ccdx, ccdy) and eight coordinates (ccdx−1, ccdy−1), (ccdx−1, ccdy), (ccdx−1, ccdy+1), (ccdx, ccdy−1), (ccdx−1, ccdy+1), (ccdx+1, ccdy+1), (ccdx+1, ccdy+1), (ccdx−1, ccdy+1) around this code edge coordinates (ccdx, ccdy) are taken out from the maximum brightness image, and an average of these brightness values is acquired as the average brightness value (AveY).

Next, in step S5205, it is determined whether or not the exposure setting index iEvNum assumes “iEvNumMax−1”. Since the exposure setting index iEvNum is “0” this time, the determination in step S5205 becomes “NO”, and in step S5206, it is further determined whether or not the exposure setting index iEvNum assumes “0”. Since the exposure setting index iEvNum is “0” this time, the determination in step S5206 becomes “YES”, and in step S5214, it is determined whether or not the average brightness value (AveY) is equal to or more than cMin1[0] and equal to or less than cMax[0]. Here, the condition that the average brightness value (AveY) is equal to or more than cMin1[0] and equal to or less than cMax[0] implies an effective brightness range under the exposure condition “0” (See FIG. 19).

When the average brightness value (AveY) is equal to or more than cMin1[0] and equal to or less than cMax[0], the determination in step S5214 becomes “YES” and the processing advances to step S5252 described later. On the other hand, when the average brightness value (AveY) is neither equal to or more than cMin1[0] nor equal to or less than cMax[0], the determination in step S5214 becomes “NO”, and in step S5215, it is also determined whether or not the average brightness value (AveY) is larger than cMax[0].

When the average brightness value (AveY) is larger than cMax[0], the determination in step S5215 becomes “YES” and the processing advances to step S5251 described later. On the other hand, when average brightness value (AveY) is not larger than cMax[0], the determination in step S5215 becomes “NO”, and in step S5230, the exposure setting index iEvNum, the average brightness value (AveY) and the code edge coordinates (ccdx, ccdy) are respectively stored and preserved in the working area 410 as the pervious-time exposure setting index iEvNumB, the previous-time average brightness value (AveYB) and the previous-time code edge coordinates (ccdxB, ccdyB) in a form of temporary preservation data. Thereafter, in step S5231, the exposure setting index iEvNum is incremented by 1, and the processing starting from step S5201 is repeated.

Further, in step S5206, when the exposure setting index iEvNum does not assume “0”, the determination in step S5206 becomes “NO”, and in step S5207, it is determined whether or not the average brightness value (AveY) is equal to or more than cMin1[iEvNum] and equal to or less than cMax[iEvNum]. If the average brightness value (AveY) is equal to or more than cMin1[iEvNum] and equal to or less than cMax[iEvNum], the determination in step S5207 becomes “YES” and the processing advances to step S5252 described later.

On the other hand, when the average brightness value (AveY) is neither equal to or more than cMin1[iEvNum] nor equal to or less than cMax[iEvNum], the determination in step S5207 becomes “NO”, and in step S5216, it is determined whether or not the average brightness value (AveY) is larger than cMax[iEvNum]. If the average brightness value (AveY) is not larger than cMax[iEvNum] this time, the determination in step S5216 becomes “NO”. Thereafter, the processing in step S5230 and the processing in step S5231 described above are performed and, then, the processing starting from step S5201 is repeated. On the other hand, when average brightness value (AveY) is larger than cMax[iEvNum], the determination in step S5216 becomes “YES”, and processing advances to step S5212 described later.

Further, if the exposure setting index iEvNum assumes “iEvNumMax−1” in step S5205, the determination in step S5205 becomes “YES”, and in step S5210, it is determined whether or not the average brightness value (AveY) is equal to or more than cMin0[iEvNum] and equal to or less than cMax[iEvNum]. If the average brightness value (AveY) is equal to or more than cMin0[iEvNum] and equal to or less than cMax[iEvNum], the determination in step S5210 becomes “YES”, and the processing advances to step S5252 described later.

If the average brightness value (AveY) is neither equal to or more than cMin0[iEvNum] nor equal to or less than cMax[iEvNum] in step S5210, the determination in step S5210 becomes “NO”, and in step S5211, it is also determined whether or not the average brightness value (AveY) is larger than cMax[iEvNum] and the exposure setting index iEvNum is not “0”. When the average brightness value (AveY) is larger than cMax[iEvNum] and the exposure setting index iEvNum is “0”, the determination in step S5211 becomes “YES”, and in step S5212, it is also determined whether or not the pervious-time exposure setting index iEvNumB is not “−1”. If the previous-time exposure setting index iEvNumB is not “−1” this time, the determination in step S5212 becomes “YES”, and in step S5213, it is also determined whether or not the previous-time average brightness value (AveYB) is equal to or more than cMin0[iEvNumB] and equal to or less than cMax[iEvNumB].

If the previous-time average brightness value (AveYB) in step S5213 is equal to or more than cMin0[iEvNumB] and equal to or less than cMax[iEvNumB], the determination in step S5213 becomes “YES”, and the processing advances to step S5250 described later. On the other hand, if the previous-time average brightness value (AveYB) is equal to or more than cMin0[iEvNumB] and equal to or less than cmax[iEvNumB], the determination in step S5213 becomes “NO” and hence, processing advances to step S5251 described later.

Further, if the average brightness value (AveY) is not larger than cMax[iEvNum] or the exposure setting index iEvNum is “0” in step S5211, the determination in step S5211 becomes “NO”, and the processing advances to step S5251 described later. Further, if the previous-time exposure setting index iEvNumB is “−1” in step S5212, the determination in step S5212 becomes “NO”, and the processing advances to step S5251 described later.

When it is determined that the code edge coordinates (ccdx, ccdy) are indeterminate in step S5203, the determination in step S5203 becomes “YES”, and in step S5220, it is further determined whether or not the exposure setting index iEvNum is “iEvNumMax−1”. If the exposure setting index iEvNum is “iEvNumMax−1” this time, the determination in step S5220 becomes “YES”, and in step S5221, it is further determined whether or not the previous-time exposure setting index iEvNumB is “−1”.

Further, if the exposure setting index iEvNum is not “iEvNumMax−1” in step S5220, the determination in step S5220 becomes “NO”, and the above-mentioned processing in step S5231 is performed and, thereafter, the processing starting from step S5201 is repeated.

Further, if the previous-time exposure setting index iEvNumB is not “−1” in step S5221, the determination in step S5221 becomes “YES”, and the processing advances to step S5250 described later. On the other hand, if the previous-time exposure setting index iEvNumB is “−1”, the determination in step S5221 becomes “NO”, and the processing advances to step S5251 described later.

This selection processing of code edges is finished after performing any one of following steps S5250 to step S5252.

In step S5250, the previous-time code edge coordinates (ccdxB, ccdyB) are determined as defined data of the code edge position (Icode, Iccdx), and are stored in the integration code edge coordinates storing region of code edge coordinates storing part 406c. That is, when the previous-time average brightness value AveB is equal to or more than cMinO[iEvNumB] and equal to or less than cMax[iEvNumB], the previous-time code edge coordinates (ccdxB, ccdyB) are determined as the defined data of the code edge position (Icode, Iccdx).

In step S5251, the code edge position (Icode, Iccdx) is determined to be indeterminate and is stored in a integration code edge coordinates storing region of a code edge coordinates storing part 406e.

In step S5252, the code edge coordinates (ccdx, ccdy) is determined as defined data of the code edge position (Icode, Iccux), and are stored in the integration code edge coordinates storing region of the code edge coordinates storing part 406e.

As described above, the selection processing of code edges is performed such that the processing for selecting one code edge position (Icode, Iccdx) out of the code edge positions (Icode, Iccdx) under the plurality of the exposure conditions is performed for every code edge position (Icode, Iccdx), and the code edges under the plurality of the exposure conditions are integrated into one code edge. To be more specific, for every code edge position (Icode, Iccdx), with respect to the code edge coordinates ranging from the code edge coordinates under the minimum exposure condition [0] to the code edge coordinates under the maximum exposure condition [iEvNumMax−1], it is determined sequentially whether or not the brightness value corresponding to the code edge coordinates falls within an effective brightness range, and the code edge coordinates under the first exposure condition which falls within the effective brightness range is selected. Accordingly, it is possible to perform the detection of the code edge position using the pick-up image under the proper exposure condition for every code edge position (Icode, Iccdx).

In this embodiment, the code edge coordinates under the first exposure condition which fall within the effective brightness range is selected. However, out of the code edge coordinates under the exposure conditions which fall within the effective brightness range, the code edge coordinates under the exposure condition where the brightness value corresponding to the code edge coordinates is closest to the center of each effective brightness range may be selected. In this case, the detection of the code edge position using the pick-up image under the further proper exposure condition can be performed.

Subsequently, in step S4003, in step S4009, lens aberration correction processing is performed by the execution of the lens aberration correction program 404i. This lens aberration correction processing is configured to correct an actual focusing position of optical flux incident in the image-pick-up optical system 30 which is influenced by the aberration of the lens aberration correction processing such that the actual focusing position approximates the ideal focusing position where the image is to be focused if the image-pick-up optical system 30 is an ideal lens.

Owing to this lens aberrations correction processing, the code edge coordinates integrated in step S4008 are corrected so as to eliminate errors due to distortion in the image-pick-up optical system 30 or the like. The thus-corrected code-edge-coordinates are stored in the aberration correction coordinates storing part 406g.

Thereafter, in step S4004, in step S4010, real-space conversion processing is performed through triangulation by the execution of the triangulation calculation program 404j. Once this real-space conversion processing starts, the aforementioned aberrations-corrected code edge coordinates in the CCD coordinate system ccdx-ccdy is converted through triangulation into 3-D coordinates defined in a real space coordinate system X-Y-Z fixed with respect to a real space. As a result, 3-D coordinate values representative of the three-dimensional shape-and-color detection result are acquired. The acquired 3-D coordinate values are stored in the 3-D coordinates storing part 406h, in association with the rotation phases PH of the corresponding respective sub-areas of the object S to be picked up.

In step S4010, because the three-dimensional shape of the object S to be picked up is measured in a spatially discrete manner as a set of a plurality of 3-D vertexes, the two-dimensional coded images are referenced in a spatially discrete manner with respect to a plurality of discrete reference lines which intersect with the line direction of each patterned light. As a result, an acquisition is made as to not only a plurality of the 3-D vertexes each corresponding to a plurality of discrete points on an outer edge of the coded image, but also a plurality of the 3-D vertexes each corresponding to a plurality of discrete points within the coded image (coordinate points on boundaries between the spatial codes detected in step S4003).

Then, by referring to FIG. 27, step S1230 depicted in FIG. 15 will be described in more detail. In FIG. 27, step S1230 is conceptually expressed in a form of a flow chart as a three-dimensional shape-and-color-detection-result generation subroutine.

The three-dimensional shape-and-color-detection-result generation subroutine starts with step S5501 to load a plurality of 3-D coordinate values from the 3-D coordinates storing part 406h in association with each one of the rotation phases PH0 to 3. In the present embodiment, the entire outer face of the object S to be picked up is divided into four partial faces (a front face, a right-side face, a left-side face, and a back face), and three-dimensional shape information is generated per each partial face. In step S5501, for all of the four faces, a plurality of 3-D coordinate values belonging to each of the four partial faces are loaded from the 3-D coordinates storing part 406h.

Subsequently, in step S5502, a rotational transform is performed for the loaded plurality of 3-D coordinate values (coordinate values of vertexes) in a manner conforming with the rotation phases PH of the respective partial faces to which the respective 3-D coordinate values belongs, whereby the plurality of 3-D coordinate values belonging to the four partial faces are combined with one another by taking the rotation phases PH of the respective partial faces into consideration. As a result, the four partial faces, which are three-dimensionally represented by the plurality of 3-D coordinate values, are combined together, to thereby synthesize 3-D shape information of a composite image indicative of the entire outer face of the object S to be picked up. At this stage, however, the three-dimensional shape information includes spatially-overlapping portions which are created due to the employment of a so-called fragmented or a multiple pick-up technique using the measurement head MH.

Subsequently, in step S5503, sets of paired spatially-overlapped portions are extracted from the generated composite image. Each set of paired overlapping portions overlap with each other over lengthwise-arrayed adjacent segments of the composite image. Further, each set of paired overlapping portions are combined (stitched) together by an approach such as the averaging of a plurality of 3-D coordinate values belonging to each set of paired overlapping portions. As a result, the spatial overlaps are removed from the three-dimensional shape information, whereby a 3-D stitched shape is generated. Data indicative of the 3-D stitched shape is stored in the 3-D stitched shape storing part 406s.

Thereafter, in step S6001, the RGB values (an R brightness value, a G brightness value, and a B brightness value) are extracted from a surface-color image, the RGB values corresponding to each coordinate value in a real coordinate space of a set of 3-D vertexes which have undergone coordinate-transformation into the 3-D coordinate system defined in the real space as described above.

The real space coordinate system, and a plane coordinate system which defines the surface-color image are geometrically related with each other by the triangulation calculation mentioned above. In other words, when there exists a conversion used for mapping, by calculation, the coded image, that is to say, the plane coordinate system defining a shape image which is a two-dimensional image for measuring the three-dimensional shape of the object S to be picked up, onto the 3-D coordinate system in the real space, the use of the inverse conversion of the aforementioned conversion enables the 3-D coordinate system in the real space to be mapped, by calculation, onto the plane coordinate system which defines the surface-color image. Therefore, step S6001 enables the surface-color values, namely, the RGB values corresponding to the 3-D vertexes, from the two-dimensional surface-color image, per each vertex. Surface color values corresponding to the respective three-dimensional vertexes and surface color values corresponding to three-dimensional space positions between the respective three-dimensional vertexes are extracted, and these surface color values are newly rearranged on the image plane. The image generated by rearrangement is stored in a stitch texture image storing part 406t as a stitch texture image.

Due to the above-mentioned steps, the execution of the three-dimensional shape-and-color-detection-result generation subroutine is finished one time, resulting in the completion of the execution of the three-dimensional shape-and-color detection processing routine shown in FIG. 27 one time.

Here, in the patterned-light illuminated image pick-up processing in step S2005, the image pick-up processing is performed with respect to all exposure time parameters stored in the parameter table storing part 406w for respective exposures. However, the time for image pick-up processing may be shortened by using some of exposure time parameters stored in the parameter table storing part 406w for respective exposures.

For example, by executing the automatic exposure (AE) function of the image pick-up part 14 (exposure determination unit) in step S1004, the exposure time parameters of three exposure conditions [iEvNum−1], [iEvNum], [iEvNum+1] close to the selected exposure condition [iEvNum] are taken out from the parameter table storing part 406w for respective exposures, and the image pick-up processing in step S2023 is performed. That is, the image pick-up processing is performed using the exposure time parameter determined most appropriate by the automatic exposure function and the adjacent exposure time parameters before and after the most appropriate exposure time parameter. Due to such an operation, even when the detection device cannot sufficiently cope with the brightness distribution of the object S to be picked up under one exposure condition determined by the automatic exposure function, with the use of the pick-up image under the exposure conditions before and after such an exposure condition, it is possible to accurately expand a range in which the detection device can cope with the brightness distribution of the object S to be picked up.

Further, even when a large number of exposure conditions for picking up the object S to be picked-up is present, there is no case in which the formation of the brightness image, the formation of the coded image and the extraction of the code edge are performed under all exposure conditions and hence, a load imposed on arithmetic processing for these operations can be reduced and, at the same time, the detection time of the three-dimensional shape is not unnecessarily required.

The execution of the automatic exposure (AE) function may be performed by the patterned-light illuminated image pick-up processing in place of performing the processing in step 1004. Further, the automatic exposure (AE) function is provided for detecting the brightness of the image pick-up region in the image pick-up part 14 and for determining the exposure condition based on the brightness.

Further, in the above-mentioned embodiment, as the example which uses some exposure conditions out of the plurality of exposure conditions, the example which uses three exposure conditions is explained. However, the number of exposure conditions is not limited to three and may be two, four or more. Further, the number of exposure conditions may be changed by setting.

Although some embodiments of the present invention have been explained in detail in conjunction with the drawings, these embodiments merely constitute exemplary embodiments, and the present invention can be carried out in other modes to which various modifications and improvement are applied based on knowledge of those who are skilled in the art based on the gist of the present invention.

For example, in this embodiment, the explanation has been made with respect to the detection of three-dimensional shape using patterned lights of the space code method. However, the detection of the three-dimensional shape may be performed using other patterned lights. For example, a light cutting method which uses simple parallel (slit-shaped) patterned lights, a method which uses a group of spot lights to which certain regularity is imparted, a method which uses patterned lights to which brightness and darkness are arranged in a meshed shape may be also applicable to the detection of the three-dimensional shape.

What is claimed is:

1. A three-dimensional shape detection device which is configured to detect a three-dimensional shape of an object to be picked up within a image pick-up region based on information on an image which is picked up by projecting patterned lights which are formed by alternately arranging brightness and darkness to the object to be picked up, the three-dimensional shape detection device comprising:
a projection part which is configured to project the respective patterned lights to the object to be picked up;
an image pick-up part which is configured to pick up the object to be picked up in a state that the patterned lights are projected from the projection part under a plurality of different exposure conditions;
a patterned light trajectory extracting unit which is configured to extract trajectory of the patterned light from a pick-up image picked up by the image pick-up part for every exposure condition;
a pattern trajectory integration unit which is configured to determine one pattern trajectory position for calculating a three-dimensional shape of the object to be picked up based on a pattern trajectory position for every exposure condition extracted by the patterned light trajectory extracting unit; and
a three-dimensional shape calculation unit which is configured to calculate the three-dimensional shape of the object to be picked up based on the pattern trajectory position determined by the pattern trajectory integration unit.

2. A three-dimensional shape detection device according to claim 1, wherein the pattern lights are constituted of plural kinds of patterned lights which are formed by alternately arranging brightness and darkness,
the projection part is configured to project the plural kinds of respective patterned lights to the object to be picked up time-sequentially,
the image pick-up part is configured to pick up the object to be picked up in a state that the respective patterned lights are projected to the object to be picked up from the projection part under a plurality of different exposure conditions, and
the patterned light trajectory extracting unit includes:
a brightness image generation unit which is configured to generate a plurality of brightness images acquired by calculating the brightnesses of the respective pixels from the respective pick-up images picked up by the image pick-up part for the respective exposure conditions;
a coded image generation unit which is configured to generate coded images for the respective exposure conditions to which the space codes are allocated for the respective pixels by performing threshold processing on the plurality of brightness images based on predetermined threshold values; and
a code edge extracting unit which is configured to perform processing for extracting code edge positions of the space codes from the coded images on the respective coded images under the respective exposure conditions, and
the pattern trajectory integration unit includes a code edge integration unit which is configured to determine one code edge position for calculating a three-dimensional shape of the object to be picked up based on the code edge positions for the respective exposure conditions extracted by the code edge extracting unit, and
the three-dimensional shape calculation unit is configured to calculate a three-dimensional shape of the object to be picked up based on the code edge positions determined by the code edge integration unit.

3. A three-dimensional shape detection device according to claim 2, further comprising:
an exposure condition information storing part which is configured to store information on a plurality of different exposure conditions; and
an exposure determination unit which is configured to detect brightness of an image pick-up region in the image pick-up part, and to determine one exposure condition from the exposure condition information storing part based on the brightness, and
the plurality of exposure pick-up processing unit adopts a plurality of exposure conditions constituted of an exposure condition determined by the exposure determination unit and exposure conditions before and after and close to the determined exposure condition as the plurality of different exposure conditions.

4. A three-dimensional shape detection device according to claim 2, wherein the code edge integration unit is configured to detect brightness of the pixel corresponding to each coordinates of the cord edge position under each exposure condition for every coordinates, to determine whether or not the brightness falls within an effective brightness range under the exposure condition, and to determine one code edge position for calculating the three-dimensional shape of the object to be picked up using the coordinates of the code edge position corresponding to the pixel which the code edge integration unit determines that the brightness of the pixel falls within the effective brightness range.

5. A three-dimensional shape detection device according to claim 4, wherein the code edge integration unit is configured to set the brightness of the pixel corresponding to each coordinate to the average brightness among the pixel and the pixels around the pixels.

6. A three-dimensional shape detection device according to claim 4, further comprising a maximum brightness image generation unit which is configured to detect a maximum brightness value of each pixel from each pick-up image picked up by the image pick-up part and to generate a maximum brightness image for every exposure condition, wherein the three-dimensional shape detection device is configured to perform the detection of the brightness of the pixel corresponding to each coordinates using the maximum brightness image.

7. A three-dimensional shape detection device according to claim 1, wherein the exposure condition is an exposure time.

8. A three-dimensional shape detection method of detecting a three-dimensional shape of an object to be picked up within a image pick-up region based on information on an image which is picked up by projecting patterned lights which are formed by alternately arranging brightness and darkness to the object to be picked up, the three-dimensional shape detection method comprising the steps of:
projecting the respective patterned lights to the object to be picked up by a projection part;
picking up the object to be picked up in a state that the respective patterned lights are projected from the projection part by an image pick-up part under a plurality of different exposure conditions;
extracting a trajectory of the patterned light from a pick-up image picked up by the image pick-up part for every exposure condition;
determining one pattern trajectory position for calculating a three-dimensional shape of the object to be picked up based on a pattern trajectory position for every extracted exposure condition; and
calculating the three-dimensional shape of the object to be picked up based on the determined pattern trajectory position.
